(19) United States
(12) Patent Application Publication
(10) Pub. No.: US 2011/0174652 A1
(43) Pub. Date: Jul. 21, 2011

(54) DISPLAY SYSTEM, DISPLAY DEVICE, CONTAINER DISPLAY SYSTEM, CONTAINER, FILM, ARTICLE AND MOUNTING MEMBER

(75) Inventors: Tadanao Ito, Tokyo (JP); Kenji Fujinuma, Tokyo (JP); Youichi Kanai, Tokyo (JP)

(73) Assignees: SHOWA DENKO K.K., Minato-ku, Tokyo (JP); SHOWA ALUMINUM CAN CORPORATION, Shinagawa-ku, Tokyo (JP)

(21) Appl. No.: 13/060,610

(22) PCT Filed: Dec. 21, 2009
(86) PCT No.: PCT/JP2009/007075

§ 371 Date: Feb. 24, 2011

(30) Foreign Application Priority Data
Dec. 22, 2008 (JP) 2008-325352
Dec. 22, 2008 (JP) 2008-325469
Apr. 6, 2009 (JP) 2009-092254

(51) Int. Cl. B65D 90/00; B32B 3/10; B32B 3/00; A47F 5/02; F16M 13/00

(52) U.S. Cl. 206/459.5; 428/195.1; 428/187; 211/78; 211/13.1; 248/309.1

(57) ABSTRACT

There is provided a display system and the like which allow the containers to be displayed with marks thereon facing a predetermined direction. The container 20 is first supplied to the display device 30 with the projecting portion 24 positioned above the upper guide 35. If the container 20 is supplied with the first and second identification marks 23a and 23b facing the width direction of the display device 30 as reference numeral 4A, the projecting portion 24 is supported by the left-hand-side and right-hand-side upper guides 351 and 352. Thereafter, the container 20 moves frontward while rotating clockwise as reference numeral 4A. When the first and second flat portions 2410 and 2420 face the width direction of the display device 30 as reference numeral 4B, the container 20 falls (down) to the placement unit, and moves to the front of the display device 30 without making circumferential rotation.

### TECHNICAL FIELD

The present invention relates to a display system, a display device, a container display system, a container, a film, an article and a mounting member.

### BACKGROUND ART

When being sold, for example, in a convenience store, containers, such as drink cans and PET bottles, filled with drink are placed to stand upright on a display device put, for example, in a display case. There, the display device as described above is arranged, for example, in a sloping state so that each container moves frontward in the display case due to its own weight. When one container at a front side (in the front row) is taken out, other containers following that container move toward the front side due to their own weight.

Here, for example, a plastic flat plate is provided, because of good sliding of containers, to a part on which the containers are placed in the display device. Meanwhile, a display device in which a large number of rotatable rollers are arranged has become available in recent years (for example, refer to Patent Literature 1). Additionally, although containers are supplied from a back side of a display device in general, there is proposed a display device allowing containers to be supplied from a front side, and allowing a container, which has moved backward, to move to the front side again so as to be displayed (for example, refer to Patent Literature 2). That is, there is proposed a display device in which a container supplied from a front side makes a U-turn and returns. Furthermore, with regard to a container, there has been proposed a can having inside concave portions and vertical ribs alternately formed, in a circumferential direction, in an inner circumferential wall of an annular convex portion formed on a bottom of the can (for example, refer to Patent Literature 3).

An outer face of a container is provided with a mark, such as a trade name or a trademark, in order to differentiate a product from other products. If this mark does not face a side from which a purchaser takes out the container, the purchaser finds it difficult to identify the product, and also the product does not look good when being displayed. For this reason, it is preferable that marks on displayed containers face a predetermined direction which is, for example, a front direction or the like.

As a conventional technique described in the official gazettes, there has been proposed a display method (for example, refer to Patent Literature 4) in which: on an upper face of a sloping shelf plate on which containers are placed, a rod-shaped guide ridge is provided to extend in a sloping direction of the shelf plate; on a bottom portion of each container, a concave fitting portion is provided to connect a position directly under a mark to a position directly under a face opposite to a face where the mark is attached; and the container is displayed by use of this guide ridge and this concave fitting portion. In this display method, plural containers are aligned in a front-back direction by having the concave fitting portions fit to the guide ridge with each of those containers put in such a position that the mark faces frontward. As a result, the containers are displayed with the marks facing frontward.

### CITATION LIST

### Patent Literature

[PTL 1]
Japanese Patent Application Laid Open Publication No. 11-155701
[PTL 2]
U.S. Pat. No. 6,502,408
[PTL 3]
Japanese Patent Application Laid Open Publication No. 2000-211624
[PTL 4]
Japanese Patent Application Laid Open Publication No. 2006-288676

### SUMMARY OF INVENTION

### Technical Problem

In Patent Literature 4 mentioned above, by performing display of the containers with the concave fitting portions being fit to the guide ridge, the marks are reliably faced frontward. In this invention, however, a supplier of the containers is required to fit the concave fitting portions to the guide ridge every time the supplier puts the container on a display device, and this makes displaying work of the containers troublesome. Additionally, in a case where the mark is formed on only one part of each of the containers, it is feared that there may occur a display failure where some of the containers are displayed with the marks facing backward. Additionally, in a store or the like, such as a convenience store, where a large number of drinks are sold, work of supplying the containers in a way to make the containers face the same direction is very extensive.

A main object of the present invention is to provide a display system and the like which, when containers are displayed so as to stand upright on the display device, allow the containers to be displayed with marks thereon facing a predetermined direction even if the containers are placed with the marks facing random directions.

### Solution to Problem

In order to attain the above objects, a display system to which the present invention is applied is a display system that makes a container to rotate appropriately during a moving process from a first position to a second position, and that makes a mark of the container face a specific direction after the container has been moved to the second position.

According to another aspect of the present invention, a display system to which the present invention is applied is a display system including: a container that has a mark attached on an outer circumferential face thereof; and a display device that displays the container. The display device includes: a movement unit that moves the container; and a rotation unit that rotates, in a circumferential direction, the container moved by the movement unit to make the mark of the container face a specific direction, when the mark does not face the specific direction.

The rotation unit supports the container from below by using a supporting portion and applies resistance force to the moving container by using the supporting portion so as to rotate the container in the circumferential direction, when the container is supplied to the display device in a state where the mark does not face the specific direction, and the rotation unit drops the container downward to stop the rotation of the container, when the mark comes to face the specific direction. The container has a first region and a second region on the outer circumferential face and in different positions in the circumferential direction, and has the mark in a position having a predetermined positional relationship with the second region, the second region having a friction coefficient lower than the first region, and the rotation unit rotates the container in the circumferential direction by applying resistance force to the first region of the container moved by the movement unit, and makes the mark of the container face the specific direction by sliding on the second region, when the mark does not face the specific direction. Moreover, the container includes, in different positions in the circumferential direction, a plurality of faces arranged in an intersecting relationship with the outer circumferential face on which the mark is attached, and the rotation unit has a contact portion that sequentially comes into contact with the plurality of faces, of the container, arranged in the intersecting relationship, the container being moved by the movement unit, and rotates the container in the circumferential direction by using the contact portion to make the mark face the specific direction.

According to another aspect of the present invention as a display device, a display device to which the present invention is applied is a display device including: a movement unit that moves a container with a mark attached on an outer circumferential face thereof; and a rotation unit that rotates, in a circumferential direction, the container moved by the movement unit to make the mark of the container face a specific direction, when the mark does not face the specific direction.

Furthermore, according to another aspect of the present invention as a container display system, a container display system to which the present invention is applied is a container display system including: a container that has a mark attached on an outer circumferential face thereof; a movement path on which the container moves while rotating; and a movement unit that is arranged below the movement path, and that moves the container without rotation. The container is allowed to drop from the movement path to the movement unit, when the mark faces a specific direction set in advance while the container is moving and rotating on the movement path.

The container display system further includes a taken-out portion from which the container moved by the movement unit is taken out. The container drops from the movement path to the movement unit when the mark comes to face the taken-out portion side, and the movement unit moves the container with the mark facing the taken-out portion side as far as the taken-out portion, the container having dropped from the movement path. The container has a portion whose width in a direction of the mark is formed as a first width, and whose width in a direction orthogonal to the direction of the mark is formed as a second width smaller than the first width, the movement path is provided with a pair of guides that are arranged side by side at an interval smaller than the first width and larger than the second width, and the container receives support for the portion from the pair of guides when the mark faces a direction other than the specific direction, and is made the support released to drop to the movement unit when the mark comes to face the specific direction. Moreover, rotation of the container on the movement path is conducted by applying resistance force to a part of the container that is going to slide and move on the movement path.

According to another aspect of the present invention, a container display system to which the present invention is applied is a container display system including: a container that has a mark attached on an outer circumferential face thereof; a first movement unit that moves the container while rotating the container; a second movement unit that moves the container to a taken-out portion for the container without rotating the container; and a delivery unit that delivers, from the first movement unit to the second movement unit, the container moved and rotated by the first movement unit, when the mark of the container faces a specific direction set in advance.

The first movement unit is arranged above the second movement unit, and the delivery unit delivers the container from the first movement unit to the second movement unit by dropping the container. The first movement unit and the second movement unit are arranged from a supplying portion of the container toward the taken-out portion, and the first movement unit is arranged from the supplying portion to a predetermined position, and is not arranged above the taken-out portion. Moreover, the container has a portion whose width in a direction of the mark is formed as a first width, and whose width in a direction orthogonal to the direction of the mark is formed as a second width smaller than the first width, the first movement unit includes a pair of guides that are arranged side by side at an interval smaller than the first width and larger than the second width, and that moves the container while rotating the container, and the delivery unit delivers the container from the first movement unit to the second movement unit by using the portion of the container and the pair of guides. The first movement unit supports the container above a position of the center of gravity of the container, and moves the container while rotating the container.

According to another aspect of the present invention as a container, a container to which the present invention is applied is a container including: a container body that has a lower portion and that is capable of being filled with a content; and a mark that is attached on an outer circumferential face of the container body. The container body has: a wide-width portion whose width in a direction of the mark is a first width, and that is capable of supporting the container body with the first width; and a narrow-width portion whose width in a direction orthogonal to the direction of the mark is a second width smaller than the first width, and that is formed continuously with the wide-width portion.

The container further includes a projecting portion that projects into a radial direction of the container body from the outer circumferential face of the container body, and the wide-width portion is formed of the projecting portion. The wide-width portion is formed at an upper part of the container body.

Furthermore, according to another aspect of the present invention as a display system, a display system to which the present invention is applied is a display system including: a container that has a mark attached thereon; and a display device that displays the container. The display device includes: a movement unit that moves the container; and a guide portion that guides movement of the container by coming into contact with the container moved by the movement unit. The container includes: a container body that has the mark attached thereon; a first contact portion that comes into contact with the guide portion when the mark faces a direction other than a specific direction, and that rotates the container body by using resistance force from the guide portion to make the mark face the specific direction; and a second contact portion that comes into contact with the guide portion when the mark faces the specific direction, and that slides the container body with respect to the guide portion.

The first contact portion and the second contact portion are formed of any one of an application material applied to the container body and an application material applied to a mounting member mounted on the container body. The guide portion is disposed from a supplying portion side, to which the container is supplied, toward a taken-out portion side, from which the container is taken out, the guide portion has a resistance force increasing member attached along a direction in which the guide portion is disposed, the resistance force increasing member increasing a resistance force applied to the container coming into contact with the guide portion, and the resistance force increasing member is attached not to the whole region but to a part of the region of the guide portion. The guide portion forms a movement route of the container, is arranged at a lateral side of the movement route, and performs guidance by coming into contact with one side of the container that is moving, and the display system further includes a rotation restricting portion that restricts rotation of the container by coming into contact with the other side of the container moving on the movement route. Moreover, the first contact portion has a plurality of projecting portions projecting from an outer face of the container body, and rotates the container body by causing the plurality of projecting portions to be opposed to a plurality of protruding portions provided for the guide portion, so as to make the mark face the specific direction.

According to another aspect of the present invention as a container, a container to which the present invention is applied is a container that is displayable in a display system including a guide portion guiding movement of a displayed object by coming into contact with the displayed object. The container includes: a container body that has a mark attached thereon; a first contact portion that comes into contact with the guide portion when the mark faces a direction other than a specific direction, and that rotates the container body by using resistance force from the guide portion to make the mark face the specific direction; and a second contact portion that comes into contact with the guide portion when the mark faces the specific direction, and that slides the container body with respect to the guide portion.

The second contact portion has concavities and convexities in and on a surface thereof, and the first contact portion is formed more smoothly than the second contact portion. The concavities and convexities of the second contact portion are formed of an application material applied to the second contact portion. Moreover, the first contact portion and the second contact portion are formed by attaching any one of a sticker and tape to at least any one of the first contact portion and the second contact portion.

According to another aspect of the present invention, a container to which the present invention is applied is a container including: a container body that is capable of being filled with a content; a mark that is attached on an outer circumferential face of the container body; a first region that has a first friction coefficient, and that is formed on the outer circumferential face of the container body; and a second region that has a second friction coefficient lower than the first friction coefficient, and that is formed on the outer circumferential face and in a different position, in a circumferential direction of the container body, from a position in which the first region is formed. The mark is arranged in a predetermined positional relationship with the second region, and is attached on the outer circumferential face so as to face a direction intersecting with one direction when the second region faces the one direction.

The mark is attached on the outer circumferential face so as to face a direction substantially orthogonal to the one direction when the second region faces the one direction.

Furthermore, according to another aspect of the present invention, a container to which the present invention is applied is a container including: a container body that is capable of being filled with a content; a mark that is attached on an outer circumferential face of the container body; a first region that is formed on an outer face of the container body, and that has a plurality of projecting portions; and a second region that is formed more smoothly than the first region, and that is formed on the outer face and in a different position, in a circumferential direction of the container body, from a position in which the first region is formed. The mark is arranged in a predetermined positional relationship with the second region, and is attached on the outer circumferential face so as to face a direction intersecting with one direction when the second region faces the one direction.

The mark is attached on the outer circumferential face so as to face a direction substantially orthogonal to the one direction when the second region faces the one direction. The container body that is formed into a tubular shape has a lower portion side closed, and the first region is formed on the lower portion of the container body. Moreover, the plurality of projecting portions in the first region are integrally formed with the container body. The first contact portion and the second contact portion are any one of being formed on a mounting member mounted on the container body, and being formed on the container body and the mounting member.

Furthermore, according to another aspect of the present invention as a film, a film to which the present invention is applied is a film that is to be mounted on an outer circumferential face of a container which is displayable in a display system including: a movement unit moving a displayed object; and a guide portion guiding movement of the displayed object by coming into contact with an outer circumferential face of the displayed object moved by the movement unit. The film includes: a first region that has a first friction coefficient; a second region that has a second friction coefficient lower than the first friction coefficient, and that is placed in a different position, in a circumferential direction of the container, from a position in which the first region is placed, when the film is mounted on the outer circumferential face of the container; and a mark that is formed in a position having a predetermined positional relationship with the second region.

At least any one of the first region and the second region is formed by applying an application material. The film is heat-shrinkable.

Furthermore, according to another aspect of the present invention as a display system, a display system to which the present invention is applied is a display system including: an article that has a mark attached on an outer circumferential face thereof; and a display device that displays the article. The display device includes: a movement path on which the article moves; and protruding portions that are arranged in a plurality of positions in a movement direction of the article, and that protrude into the movement path. The article includes: an article body portion that has the outer circumferential face; a plurality of contact portions that are arranged in a circumferential direction of the article body portion and within a predetermined range in the circumferential direction, and that are capable of coming into contact with the protruding portions provided in the display device; and a region that is adjacent to the predetermined range in the circumferential direction, and in which the plurality of contact portions are not provided. The plurality of contact portions sequentially come into contact with the protruding portions to rotate, in the circumferential direction, the article moving on the movement path, when the mark of the article does not face a specific direction. The region is opposed to a side on which the protruding portions are provided, to move the article without rotation, when the mark faces the specific direction.

The plurality of contact portions are arranged in positions different from each other in a height direction of the article. The protruding portions are provided in positions different from each other in a height direction so that each of the protruding portions comes into contact with one contact portion among the plurality of contact portions and does not come into contact with the other contact portions. Moreover, the plurality of contact portions are formed of projecting portions that project into a radial direction of the article body portion from the outer circumferential face. The article further includes a mounting member mounted on the article body portion, and the plurality of contact portions and the region are formed on the mounting member, and are provided for the article by mounting the mounting member on the article body portion.

Furthermore, according to another aspect of the present invention as a display device, a display device to which the present invention is applied is a display device that is capable of displaying an article which includes: an outer circumferential face with a mark attached thereon; and a plurality of faces having an intersecting relationship with the outer circumferential face, in different positions in a circumferential direction and within a predetermined range in the circumferential direction. The display device includes: a movement path on which the article moves; and a rotation unit that sequentially comes into contact with the plurality of faces having the intersecting relationship to rotate the article moving on the movement path, when the mark of the article faces a direction other than a specific direction, and that is opposed to a face which is the outer circumferential face of the article moving on the movement path and on which the plurality of faces having the intersecting relationship are not provided, when the mark of the article faces the specific direction.

The rotation unit is provided so that a position thereof in a height direction is adjustable. The rotation unit includes protruding portions protruding into the movement path, in a plurality of positions in a movement direction of the article, and causes the protruding portions to sequentially come into contact with the plurality of faces having the intersecting relationship so as to perform rotation of the article.

According to another aspect of the present invention as an article, an article to which the present invention is applied is an article including: an article body portion that has an outer circumferential face with a mark attached thereon; and a face forming portion that is arranged in a predetermined positional relationship with the mark, and that is provided, in a circumferential direction of the article body portion, with a plurality of faces arranged in an intersecting relationship with the outer circumferential face.

The article further includes a portion that is arranged in a predetermined positional relationship with the mark, that is provided, in the circumferential direction, so as to be adjacent to the face forming portion, and on which the plurality of faces arranged in the intersecting relationship are not provided. The portion on which the plurality of faces arranged in the intersecting relationship are not provided is arranged so as to face a direction substantially orthogonal to one direction when the mark faces the one direction. Furthermore, the article further includes another face forming portion in a position different from a position of the face forming portion in a height direction. A plurality of the marks are provided in different positions in the circumferential direction, the face forming portion is arranged in the predetermined positional relationship with one mark among the plurality of marks, and the article further includes another face forming portion arranged in a predetermined positional relationship with the another mark among the plurality of marks. Moreover, the face forming portion arranged in the predetermined positional relationship with the other mark is arranged in a different position, in a height direction, from a position of the face forming portion arranged in the predetermined positional relationship with the one mark. The plurality of faces arranged in the intersecting relationship are arranged in positions different from each other in a height direction of the article body portion.

Further, according to another aspect of the present invention as a mounting member, a mounting member to which the present invention is applied is a mounting member that is to be mounted on an article with a mark attached thereon. The mounting member includes: a body portion that has an outer circumferential face, and that is mounted on the article; and a face forming portion that is provided, in a circumferential direction of the body portion, with a plurality of faces arranged in an intersecting relationship with the outer circumferential face, and that is placed in a position having a predetermined positional relationship with the mark, when the body portion is mounted on the article in a state where the article and the body portion have a predetermined positional relationship.

### Advantageous Effects of Invention

It is possible to provide a display system and the like which, when containers are displayed so as to stand upright on the display device, allow the containers to be displayed with marks thereon facing a predetermined direction even if the containers are placed with the marks facing random directions.

### BRIEF DESCRIPTION OF DRAWINGS

FIG. 1 is a view showing a schematic configuration of a display device according to the first exemplary embodiment of the present invention.

FIG. 2 is a view illustrating the upper guide.

FIG. 3 is a view for explaining the container to be displayed in the display device.

FIG. 4 is a view showing the behavior of the container in the display device.

FIG. 5 is a top view of the upper guide in the second exemplary embodiment.

FIG. 6 is a view showing the container according to the second exemplary embodiment.

FIG. 7 is a view showing behavior of the container in the display device.

FIG. 8 is a view for explaining the display device according to the third exemplary embodiment.

FIG. 9 is a view showing the container according to the third exemplary embodiment.

FIG. 10 is a view showing behavior of the container in the display device.

FIG. 11 is a view showing a modified example of the display device.

FIG. 12 is a view showing another configuration of the display device.

FIG. 13 is a view illustrating the fourth exemplary embodiment.

FIG. 14 is a view showing a schematic configuration of the display device according to the fifth exemplary embodiment.

FIG. 15 is a view of the display device and the container when seen from the front side thereof.

FIG. 16 is a top view of the display device.

FIG. 17 is a view for explaining the container.

FIG. 18 is a view for explaining the behavior of the container in the display device.

FIG. 19 is a view showing a printing machine that performs printing on the container.

FIG. 20 is a view showing experimental conditions for measurement of static friction coefficients between the surfaces of various cans and resistance materials, and a table showing experimental results.

FIG. 21 is a table showing test results.

FIG. 22 is a table showing test results when every other one of the roll-shaped members is fixed.

FIG. 23 is a table showing test results when all the roll-shaped members are fixed.

FIG. 24 is a view showing the display device according to the sixth exemplary embodiment.

FIG. 25 is a view for explaining the container.

FIG. 26 is a view for explaining the behavior of the container in the display device.

FIG. 27 is a view showing another configuration of the container.

FIG. 28 is a view showing another configuration of the container.

FIG. 29 is a view of the container with tape, whose region is divided into four in the length direction thereof, attached on the whole circumference of the container.

FIG. 30 is a view of the mounting member on which tape having regions different in friction coefficients is attached.

FIG. 31 is a view illustrating the regions when the identification marks do not face each other with their phases shifted 180 degrees.

FIG. 32 is a view of the container using a shrink film on which coating materials different in frictional resistance are applied.

FIG. 33 is a view showing a schematic configuration of the display device according to the seventh exemplary embodiment.

FIG. 34 is a top view and a side view of the display device.

FIG. 35 is a cross-sectional view taken along the line XXXV-XXXV in FIG. 34.

FIG. 36 is a view showing a modified example of the display device.

FIG. 37 is a view showing a modified example of the display device.

FIG. 38 is a view showing a modified example of the display device.

FIG. 39 is a view for explaining the container.

FIG. 40 is a view for explaining the container.

FIG. 41 is a view for explaining the behavior of the container in the display device.

FIG. 42 is a view showing another example of behavior of the container.

FIG. 43 is a view showing another example of behavior of the container.

FIG. 44 is a view showing a modified example of the container.

FIG. 45 is a view showing a modified example of the container.

FIG. 46 is a view showing a modified example of the display device.

FIG. 47 is a view showing another modified example of the container.

FIG. 48 is a view showing another modified example of the container.

FIG. 49 is a view for explaining the behavior of the container in the display device.

FIG. 50 is a view showing another modified example of the container.

FIG. 51 is a view showing another modified example of the container.

FIG. 52 is a view for explaining the behavior of the container in the display device.

FIG. 53 is a view for explaining the arrangement positions of the identification marks on the container.

FIG. 54 is a view showing another modified example of the container.

FIG. 55 is a view showing the container according to the eighth exemplary embodiment.

FIG. 56 is a view showing the container according to the eighth exemplary embodiment.

FIG. 57 is a view showing the behavior of the container in the display device.

FIG. 58 is a view showing a modified example of the container.

FIG. 59 is a view showing a modified example of the container.

FIG. 60 is a view showing another modified example of the container.

FIG. 61 is a view showing another modified example of the container.

FIG. 62 is a view showing behavior of the container in the display device.

FIG. 63 is a view showing another example of the modified examples of the container.

FIG. 64 is a view showing another example of the modified examples of the container.

FIG. 65 is a view showing another example of the modified examples of the container and so on.

FIG. 66 is a view showing another example of the modified examples of the container.

FIG. 67 is a view showing another example of the modified examples of the container.

FIG. 68 is a view illustrating an aspect of the arrangement of the first to fifth protrusions.

FIG. 69 is a view showing another modified example of the container.

FIG. 70 is a view showing another modified example of the container.

FIG. 71 is a view for explaining the behavior of the container in the display device.

### DESCRIPTION OF EMBODIMENTS

Exemplary embodiments for carrying out the present invention will be described below in detail with reference to the accompanying drawings.

### First Exemplary Embodiment

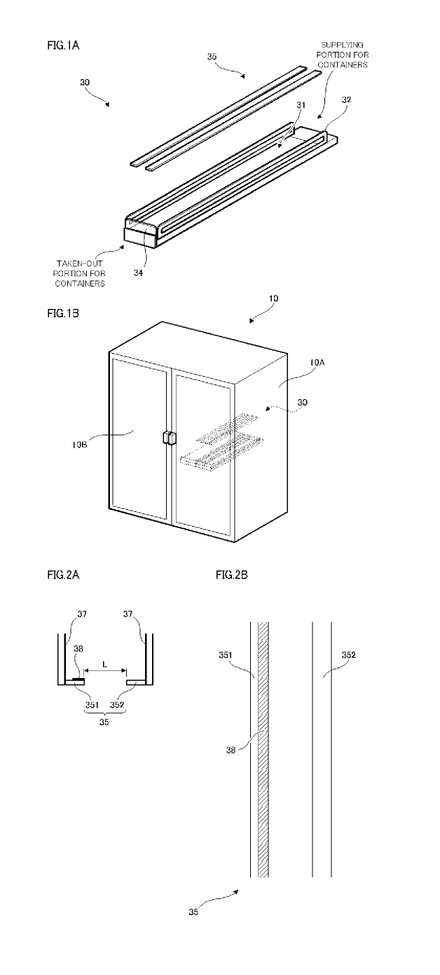

FIG. 1 (FIGS. 1A and 1B) is a view showing a schematic configuration of a display device according to the first exemplary embodiment of the present invention.

As shown in FIG. 1A, a display device 30 according to this exemplary embodiment includes: a placement unit 31 functioning as a movement unit that moves, without rotating, containers (to be described later) with drink filled therein; and guides 32 that form a movement route (a transportation route) of the containers, that are arranged at a lateral side of this movement route, and that prevent the containers from moving away from the movement route. The display device 30 also includes a regulation plate 34 that is formed transparently and arranged along one side of the placement unit 31, and that stops movement of the containers 20. The display device 30 also includes an upper guide 35 that is arranged along the movement route of the containers and arranged above the placement unit 31, and that guides the movement of the containers (form a movement path of the containers). Furthermore, the display device 30 includes a supporting frame (not shown in the figure) that supports the upper guide 35. The placement unit 31 may be made of a low-friction plate such as acrylic, or made more smoothly with rollers.

The display device 30 is, as shown in FIG. 1B, put inside a display case 10 installed in a convenience store, a super market or the like. This display case 10 includes: a case main body unit 10A formed into a rectangular parallelepiped shape; and doors 10B provided so as to be openable and closable with respect to this case main body unit 10A, which form a main part of the display case 10.

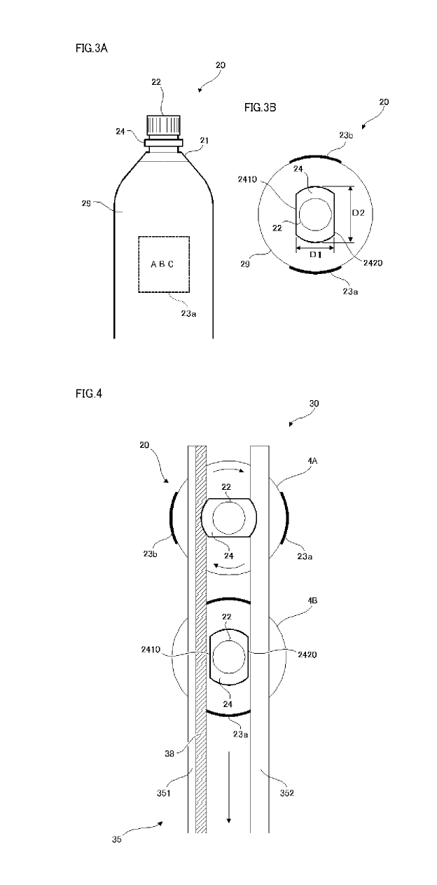

Here, the display device 30 is placed on a shelf (not shown in the figure) provided to the display case 10. On this occasion, the display device 30 is placed so that the side thereof where the regulation plate 34 is provided is located at the side where the doors 10B are provided. Additionally, the placement unit 31 of the display device 30 is arranged so that the side thereof where the regulation plate 34 is provided is positioned at a lower level than a side thereof opposite to the side where the regulation plate 34 is provided. That is, the placement unit 31 is arranged in a downward sloping state from a back side of the display case 10 toward a front side thereof (a side of a taken-out portion) from which the containers 20 (see FIGS. 3A and 3B) are taken out. The upper guide 35 is also arranged in the downward sloping state from the back side of the display case 10 toward the front side thereof from which the containers 20 are taken out.

Here, the display case 10 in this exemplary embodiment also has a door (not shown in the figure) provided on the back side thereof, whereby the back side becomes also openable. The containers 20 are supplied to the display device 30 from this back side. That is, the display case 10 has a configuration where a supplying portion for the containers 20 is provided at the back side of the display case 10, and at the back side of the display device 30. The containers 20 having been supplied move toward the side of the doors 10B. That is, the containers 20 having been supplied move toward purchasers who purchase the containers 20. Note that, in this description of the invention, the side where the doors 10B are provided is sometimes referred to as a front side (frontward), whereas the side opposite to the doors 10B is sometimes referred to as a back side (backward). The width direction (a direction orthogonal to a direction in which the containers 20 move) of the display case 10 is sometimes referred to as a lateral direction, or as a width direction.

Description will be given with regard to the display device 30 in more detail.

FIG. 2 (FIGS. 2A and 2B) is a view illustrating the upper guide 35. Here, FIG. 2A is a view when seen from the front side of the upper guide 35, and FIG. 2B is a top view of the upper guide 35.

As described above, the display device 30 is provided with the upper guide 35 above the placement unit 31. The upper guide 35 is formed with a left-hand-side upper guide 351 arranged on the left side and a right-hand-side upper guide 352 arranged on the right side, as shown in FIG. 2A. That is, the upper guide 35 is formed with the left-hand-side upper guide 351 and the right-hand-side upper guide 352 arranged in parallel in the width direction of the display device 30.

The left-hand-side upper guide 351 and the right-hand-side upper guide 352 have cross sections thereof formed into rectangular and upper faces thereof formed flat. The left-hand-side upper guide 351 and the right-hand-side upper guide 352 are arranged with a gap L therebetween. That is, the left-hand-side upper guide 351 and the right-hand-side upper guide 352 are arranged in a state being separated with the gap L therebetween. The left-hand-side upper guide 351 and the right-hand-side upper guide 352 has one end portions thereof fixed to supporting portions 37 extending downward from the above-mentioned supporting frame (not shown in the figure).

As shown in FIGS. 2A and 2B, a resistance application portion 38 that applies sliding resistance (frictional resistance) to the containers is attached to the top face of the left-hand-side upper guide 351. The resistance application portion 38 is attached along a direction in which the left-hand-side upper guide 351 is disposed (the front-back direction of the display device 30). The resistance application portion 38 may be formed of a rubber member, for example, EPDM (ethylene-propylene rubber) or the like.

Next, the containers to be displayed in the display device 30 will be described.

FIG. 3 (FIGS. 3A and 3B) is a view for explaining the container to be displayed in the display device 30. FIG. 3A shows a front elevational view, and FIG. 3B shows a top view.

The container 20 shown in FIGS. 3A and 3B illustrate a container made by injection molding (blow molding) using a resin material such as PET.

As shown in FIG. 3A, the container 20 according to this exemplary embodiment includes: a container body 21 that has an opening (a lip) in an upper portion thereof, and that is formed into a tubular form and filled with drink therein; and a cap 22 that closes the opening of the container body 21. A film 29 is mounted on the container 20.

The film 29 is mounted on an outer circumferential face of the container body 21. A first identification mark 23a and a second identification mark 23b for differentiating the container 20 from other products, such as a trade name or a trademark, are printed on the film 29, as shown in FIGS. 3A and 3B (note that, in this description, these marks will be referred to simply as “identification marks 23” in some cases). The first identification mark 23a and the second identification mark 23b may be the same configuration, or different configurations. Note that the first identification mark 23a and the second identification mark 23b are arranged so that their phases are shifted 180 degrees in a circumferential direction of the container 20.

Also, the container 20 includes a projecting portion 24 that is provided above the container body 21 (below the cap 22) and that projects from the outer circumferential face of the container body 21 in a radial direction of the container body 21.

Here, the projecting portion 24 is integrally formed with the container body 21. Also, the projecting portion 24 is in a form of a partially cut-off circle having a diameter D2, as shown in FIG. 3B. As mentioned in addition, the projecting portion 24 has a shape in which the circle having the diameter D2 is provided partially with chamfered portions. As further described, the projecting portion 24 is such that one part of the circle having the diameter D2 is provided with a first flat portion 2410, and that another part thereof is provided with a second flat portion 2420.

Here, the first flat portion 2410 and the second flat portion 2420 are arranged in parallel relation to each other. Also, the first flat portion 2410 and the second flat portion 2420 are arranged with a distance D1 therebetween. As further described, a relationship with the identification marks 23 is such that the first flat portion 2410 and the second flat portion 2420 are arranged with their phases shifted 90 degrees with respect to those of the first identification mark 23a and the second identification mark 23b.

As described additionally, a dimensional relation with the above-mentioned gap L (see FIG. 2A) is such that the diameter D2 is larger than the gap L. That is, the relation is the diameter D2>the gap L. Also, the above-mentioned distance D1 is smaller than the gap L. That is, the relation is the distance D1<the gap L.

As further described, when any one of the first identification mark 23a and the second identification mark 23b faces toward the front of the display device 30 (see FIGS. 1A and 1B), a width of the projecting portion 24 is smaller than the gap L. Also, when any one of the first identification mark 23a and the second identification mark 23b faces any direction other than frontward (for example, the width direction of the display device 30), the width of the projecting portion 24 is larger than the gap L.

As further described, the width of the projecting portion 24 in a direction in which any one of the first identification mark 23a and the second identification mark 23b faces is D2, whereas the width of the projecting portion 24 in a direction orthogonal to the direction in which any one of the first identification mark 23a and the second identification mark 23b faces is D1 smaller than D2.

Thus, in this exemplary embodiment, when the identification mark 23 faces a direction other than frontward, the container 20 is supported by the upper guide 35, whereas when the identification mark 23 faces frontward, the container 20 falls from the upper guide 35 (details will be described later).

Note that a portion of the projecting portion 24 having the diameter D2 may be considered as a wide-width portion, and a portion of the projecting portion 24 between a part where the first flat portion 2410 is provided and a part where the second flat portion 2420 is provided may be considered as a narrow-width portion.

Description will now be given with regard to behavior of the container 20 in the display device 30.

FIG. 4 is a view showing the behavior of the container 20 in the display device 30.

In the display device 30 according to this exemplary embodiment, the container 20 is first supplied to the display device 30 with the projecting portion 24 positioned above the upper guide 35. As mentioned in addition, the container 20 is supplied to the display device 30 with the container 20 suspended by the upper guide 35. In this exemplary embodiment, the container 20 is supported above the position of its center of gravity by the upper guide 35. Thus, the container 20 is stable in its rotation (to be described later), as compared to the container 20 as supported below the position of its center of gravity.

Here, if, at the time of supply of the container 20 to the display device 30, the first identification mark 23a and the second identification mark 23b face, for example, the width direction of the display device 30 as indicated by the reference numeral 4A in FIG. 4, the projecting portion 24 is supported by the left-hand-side upper guide 351 and the right-hand-side upper guide 352. That is, the portion of the projecting portion 24 having the above-mentioned diameter D2 is supported by the left-hand-side upper guide 351 and the right-hand-side upper guide 352.

After that, the container 20 starts frontward sliding movement. However, the left-hand-side upper guide 351 is provided with the resistance application portion 38, and thus, resistance force is applied to the container 20 on the left-hand side thereof, so that the container 20 is restricted in its movement on the left-hand side thereof. On the other hand, the container 20 is going to move frontward on the right-hand side thereof. Thus, the container 20 moves frontward while making clockwise rotation (in the circumferential direction thereof) as indicated by the reference numeral 4A. Here, the upper guide 35 may be considered as a first movement unit that moves the container 20 while rotating the container 20.

Then, when the first flat portion 2410 and the second flat portion 2420 come to face the width direction of the display device 30 as indicated by the reference numeral 4B, the projecting portion 24 may pass through the gap between the left-hand-side upper guide 351 and the right-hand-side upper guide 352, and the container 20 thus falls (down) to the placement unit 31 (see FIG. 1A). As mentioned in addition, the container 20 is delivered from the upper guide 35 to the placement unit 31. When falling, the container 20 is in a position for example with the first identification mark 23a facing frontward. Then, the container 20 that has fallen to the placement unit 31 moves to the front of the display device 30 without making circumferential rotation (with the first identification mark 23a facing frontward). Here, the placement unit 31 may be considered as a second movement unit that moves the container 20 to the taken-out portion for the container 20 without rotating the container 20.

In this exemplary embodiment, even if the container 20 is supplied for example with the first identification mark 23a facing the width direction of the display device 30 as indicated by the reference numeral 4A, the first identification mark 23a comes to face frontward in a stage where the container 20 reaches the front. Thus, even if placement (supply) of the container 20 is made without the first identification mark 23a facing frontward, the first identification mark 23a ends up facing frontward when the container 20 reaches the front side of the display case 10 (see FIG. 1B). In other words, even if a supplier who supplies the containers 20 to the display device 30 does not perform any particular operations, the first identification marks 23a may be made to face frontward.

### Second Exemplary Embodiment

Description will now be given with regard to the second exemplary embodiment.

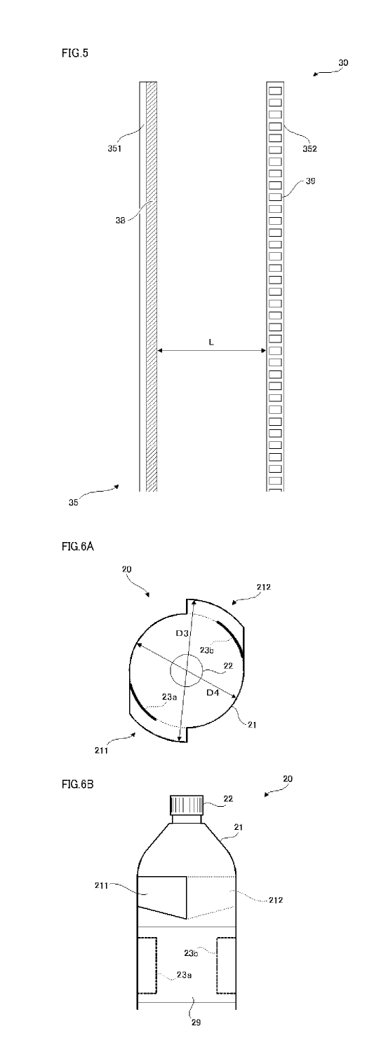

FIG. 5 is a top view of the upper guide 35 in the second exemplary embodiment.

The upper guide 35 in this exemplary embodiment has the same configuration as the upper guide 35 in the first exemplary embodiment. In the present exemplary embodiment, however, the top face of the right-hand-side upper guide 352 is provided with plural roll-shaped members 39 rotatable in the movement direction of the containers 20 and arrayed in the front-back direction. Also, in this exemplary embodiment, the gap L between the left-hand-side upper guide 351 and the right-hand-side upper guide 352 is larger than that in the first exemplary embodiment, for adaptation to the size of the container 20 to be described later.

FIG. 6 (FIGS. 6A and 6B) is a view showing the container 20 according to the second exemplary embodiment. FIG. 6A is a top view, and FIG. 6B is a front elevational view. FIGS. 6A and 6B also illustrate the container 20 made of a resin material such as PET.

As shown in FIGS. 6A and 6B, the container body 21 of the container 20 according to this exemplary embodiment includes a first projecting portion 211 and a second projecting portion 212 provided on the outer circumferential face and projecting in the radial direction of the container body 21. Here, the first projecting portion 211 and the second projecting portion 212 are arranged with their phases shifted 180 degrees in the circumferential direction of the container body 21.

Also, the container 20 has the first identification mark 23a below the first projecting portion 211, and the second identification mark 23b below the second projecting portion 212. The first identification mark 23a and the second identification mark 23b are printed on the film 29, as in the case of the above-mentioned first exemplary embodiment.

Also, the first projecting portion 211 and the second projecting portion 212 of the container 20 are such that their respective bottom faces that come into contact with the upper guide 35 slope circumferentially. In this exemplary embodiment, the first projecting portion 211 and the second projecting portion 212 are illustrated to have the sloping bottom faces; however, these projecting portions may be configured as not being sloped.

Further, in the container 20 according to this exemplary embodiment, an outer edge portion of the first projecting portion 211 and an outer edge portion of the second projecting portion 212 extend along a circle having a diameter D3. On the other hand, the diameter of the container body 21 is D4 smaller than the diameter D3. Here, the diameter D3 is larger than the above-mentioned gap L (see FIG. 5) between the left-hand-side upper guide 351 and the right-hand-side upper guide 352, whereas the diameter D4 is smaller than the gap L.

As further described, when any one of the first identification mark 23a and the second identification mark 23b faces toward the front of the display device 30 (see FIGS. 1A and 1B), a width of the container body 21 (the width thereof in the width direction of the display device 30) is D4 smaller than the above-mentioned gap L. Also, when any one of the first identification mark 23a and the second identification mark 23b faces a direction other than frontward (for example, the width direction of the display device 30), the width of the container body 21 is D3 larger than the above-mentioned gap L.

Thus, also in this exemplary embodiment, when the identification mark 23 faces the direction other than frontward, the container 20 is supported by the upper guide 35, whereas when the identification mark 23 faces frontward, the container 20 falls from the upper guide 35.

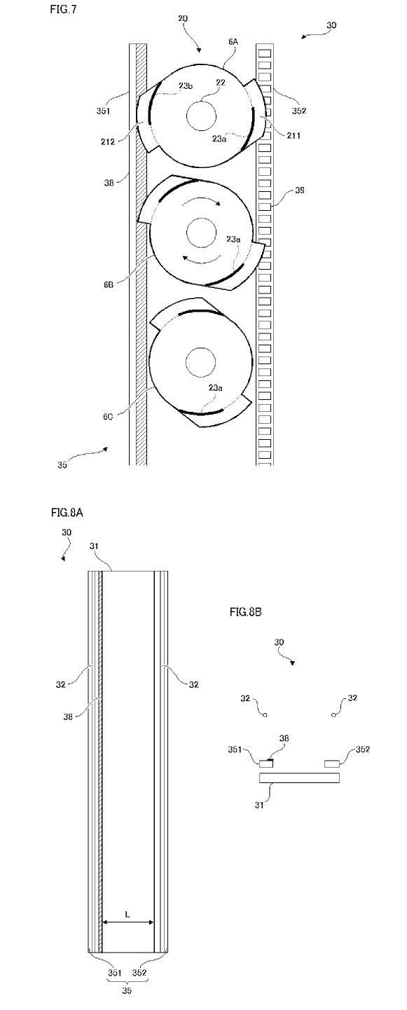

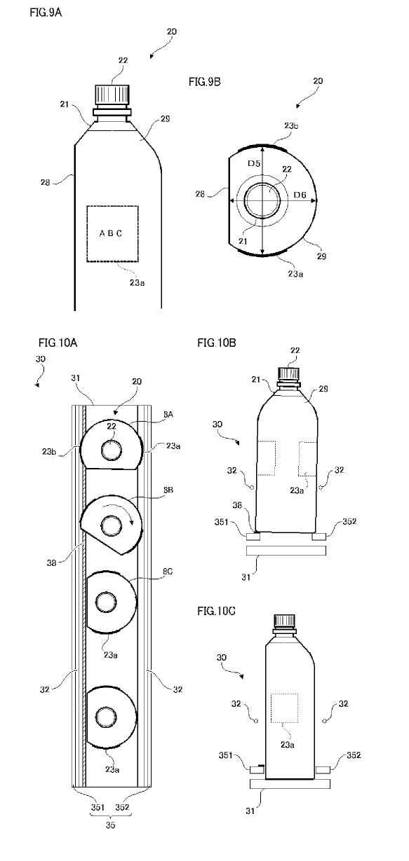

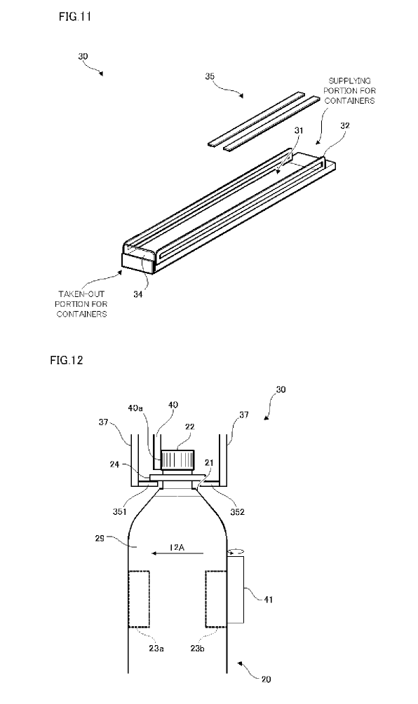

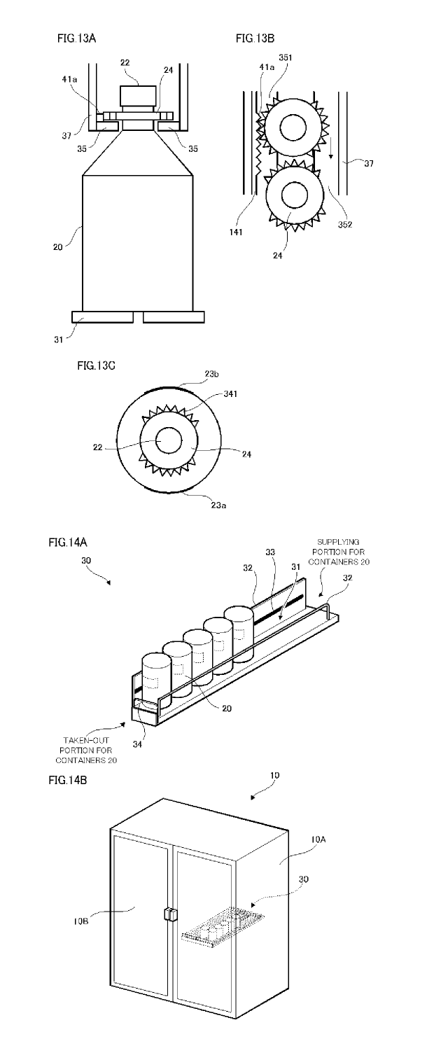

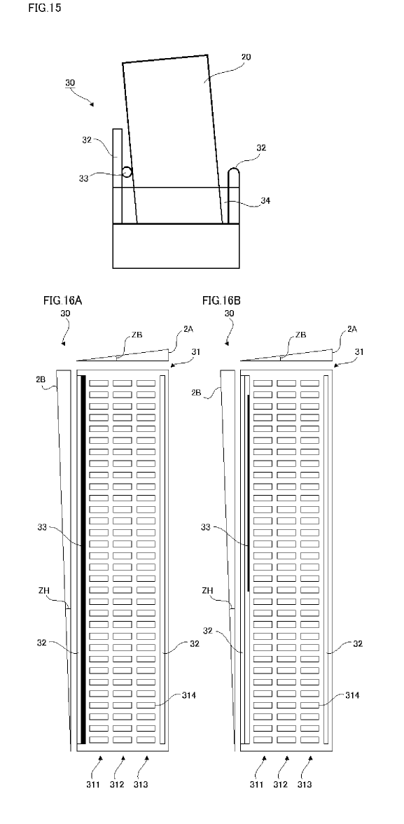

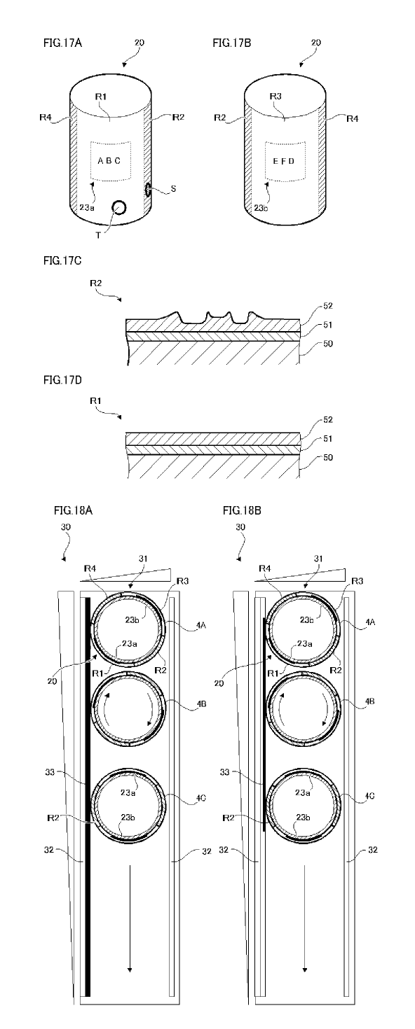

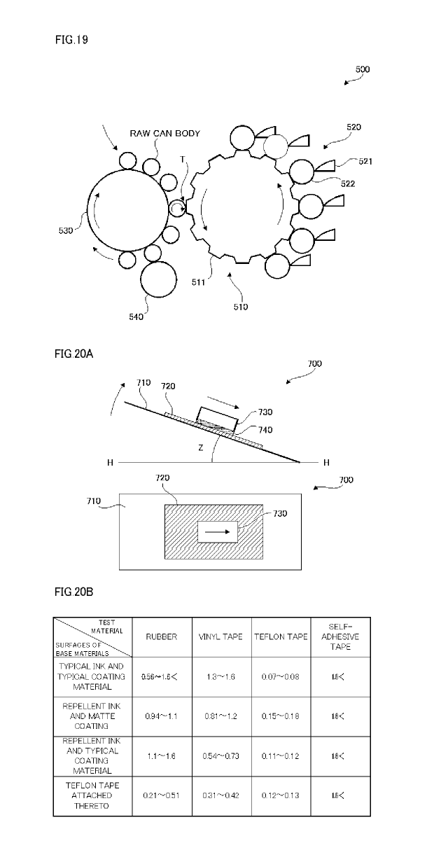

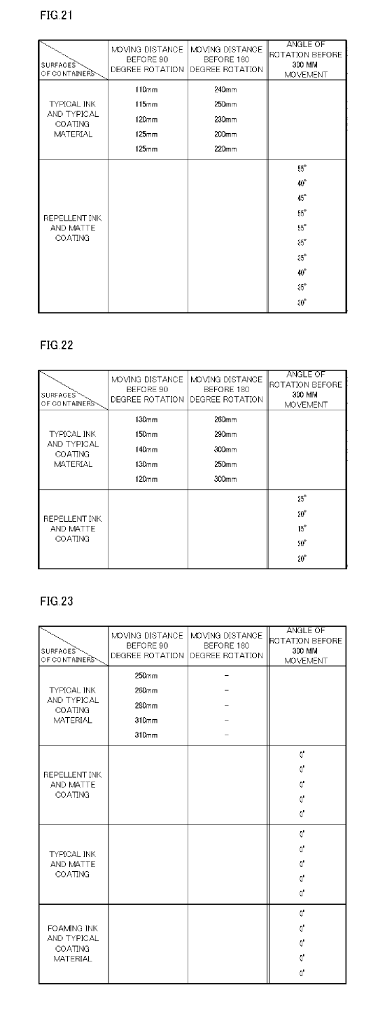

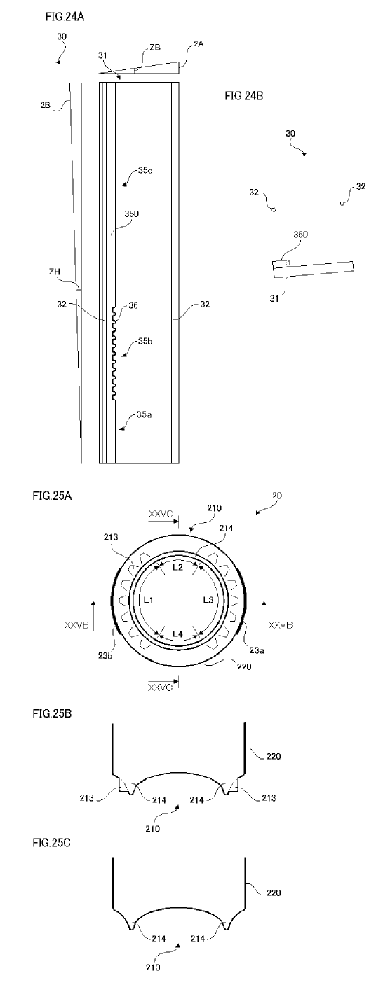

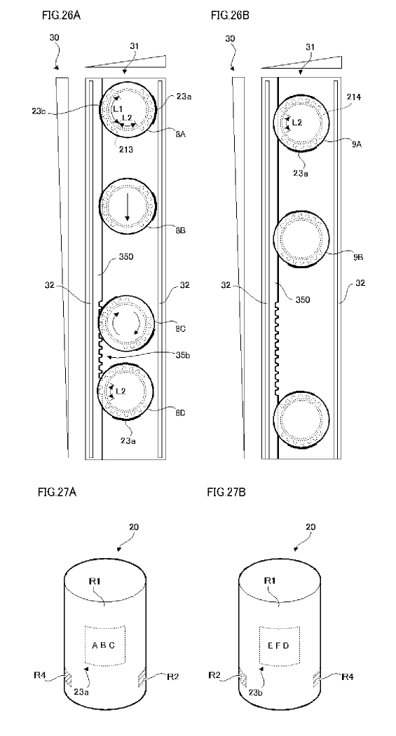

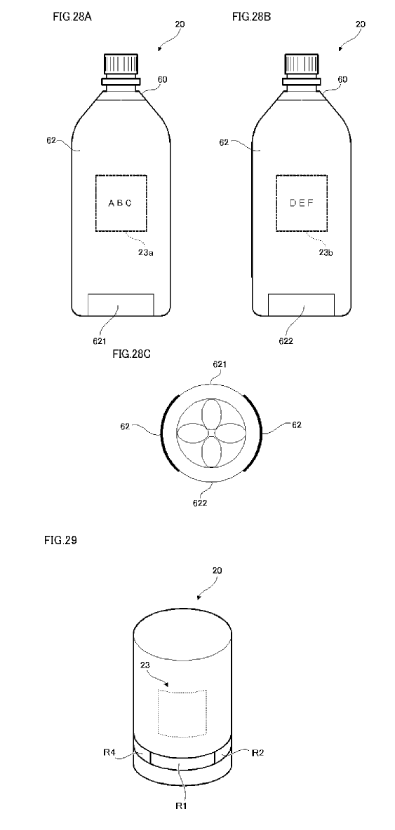

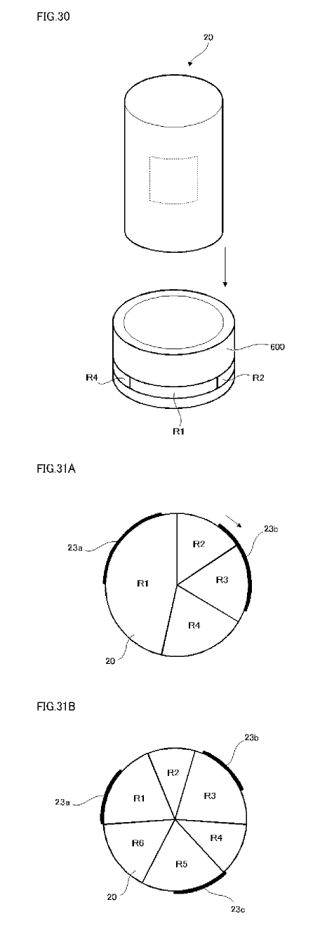

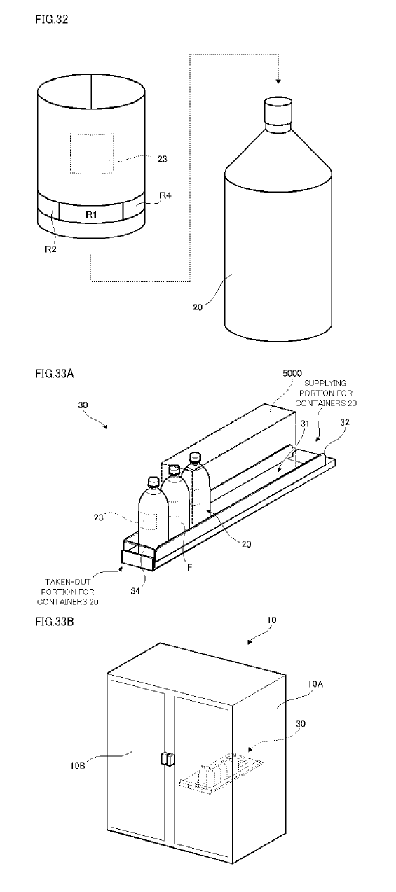

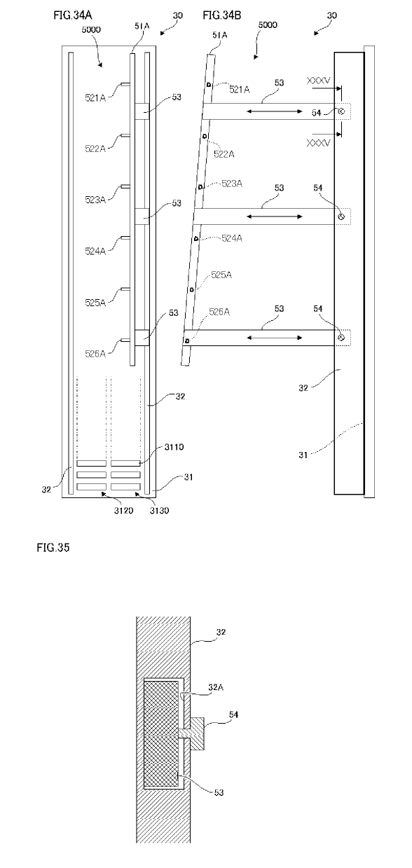

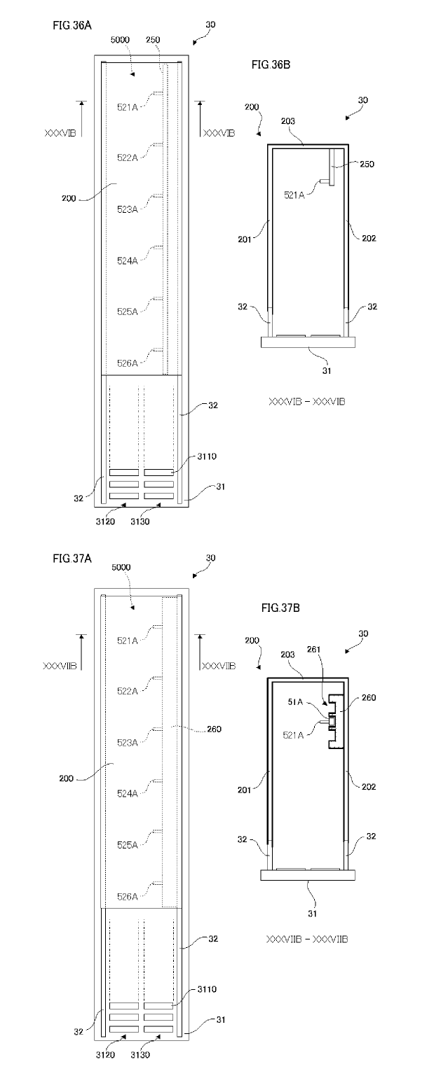

Here, FIG. 7 is a view showing behavior of the container 20 in the display device 30.

If the container 20 is supplied to the display device 30 for example with the first identification mark 23a facing rightward as indicated by the reference numeral 6A in FIG. 7, the first projecting portion 211 is supported by the right-hand-side upper guide 352, while the second projecting portion 212 is supported by the left-hand-side upper guide 351, because of a relation, the diameter D3>the gap L, as mentioned above.

Then, from this state, the container 20 starts frontward movement; however, also in this exemplary embodiment, the container 20 is restricted (regulated) in its movement on the left-hand side thereof. Thus, the container 20 moves frontward while making clockwise rotation (see the reference numeral 6B). Then, when the first identification mark 23a comes to face frontward (see the reference numeral 6C), the supporting of the first projecting portion 211 and the second projecting portion 212 by the upper guide 35 is released, and the container 20 thus falls to the placement unit 31 (see FIG. 1A). After that, the container 20 moves to the front of the display device 30 without rotating.

### Third Exemplary Embodiment

Description will now be given with regard to the third exemplary embodiment.

FIG. 8 (FIGS. 8A and 8B) is a view for explaining the display device 30 according to the third exemplary embodiment.

As in the case of the above, the display device 30 according to this exemplary embodiment is also provided with the left-hand-side upper guide 351 and the right-hand-side upper guide 352. In this exemplary embodiment, however, the left-hand-side upper guide 351 and the right-hand-side upper guide 352 are provided at a position nearer to the placement unit 31 than the first exemplary embodiment and the second exemplary embodiment.

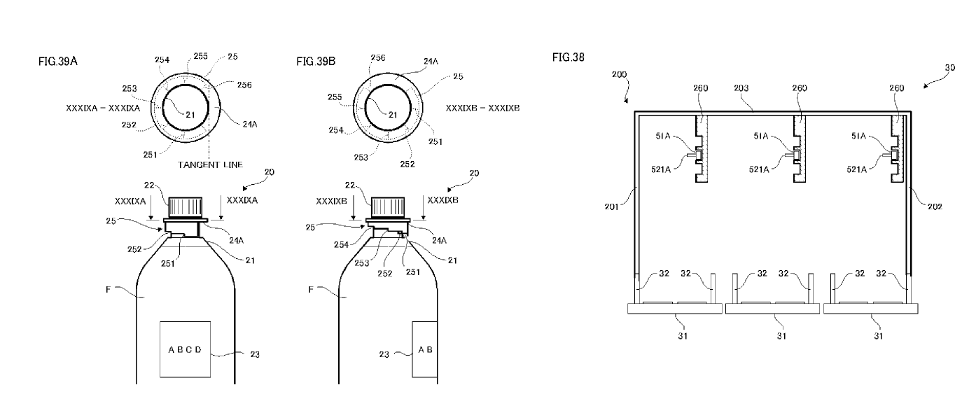

FIG. 9 (FIGS. 9A and 9B) is a view showing the container 20 according to the third exemplary embodiment. FIG. 9A is a front elevational view of the container 20, and FIG. 9B is a top view of the container 20.

As shown in FIGS. 9A and 9B, the container body 21 according to this exemplary embodiment, although cylindrical in basic form, includes a flat portion 28 that is provided in a part of the outer circumferential face, formed in a chamfered form and also arranged extending in a top-bottom direction.

Here, the container body 21 is formed with a diameter D5. The diameter D5 is larger than the gap L (see FIG. 8A) between the left-hand-side upper guide 351 and the right-hand-side upper guide 352. That is, there is a relation, the diameter D5>the gap L. Also, the container body 21 in this exemplary embodiment is such that a distance between the flat portion 28 and the outer circumferential face (the outer circumferential face of the container body 21) on the opposite side thereof to a part where the flat portion 28 is provided is D6. The distance D6 is smaller than the gap L. That is, there is a relation, the distance D6<the gap L. Also, in this exemplary embodiment, the first identification mark 23a and the second identification mark 23b are arranged with their phases shifted 90 degrees with respect to the position of the flat portion 28.

As further described, when any one of the first identification mark 23a and the second identification mark 23b faces toward the front of the display device 30 (see FIGS. 1A and 1B), the width of the container body 21 (the width thereof in the width direction of the display device 30) is D6 smaller than the above-mentioned gap L. Also, when any one of the first identification mark 23a and the second identification mark 23b faces a direction other than frontward (for example, the width direction of the display device 30), the width of the container body 21 is D5 larger than the above-mentioned gap L.

Thus, also in this exemplary embodiment, when the identification mark 23 faces the direction other than frontward, the container 20 is supported by the upper guide 35, whereas when the identification mark 23 faces frontward, the container 20 falls from the upper guide 35.

Here, FIG. 10 (FIGS. 10A to 10C) is a view showing behavior of the container 20 in the display device 30.

If the container 20 is supplied to the display device 30 for example with the first identification mark 23a facing rightward as indicated by the reference numeral 8A in FIG. 10A and as shown in FIG. 10B, the container 20 is supported on the right-hand side thereof by the right-hand-side upper guide 352, while the container 20 is supported on the left-hand side thereof by the left-hand-side upper guide 351, because of the relation, the diameter D5>the gap L, as mentioned above.

Then, from this state, the container 20 starts frontward movement; however, also in this exemplary embodiment, the container 20 is restricted in its movement on the left-hand side thereof. Thus, the container 20 moves frontward while making clockwise rotation (see the reference numeral 8B). Then, when the first identification mark 23a comes to face frontward, the supporting of the container 20 by the upper guide 35 is released, and the container 20 thus falls to the placement unit 31 (see the reference numeral 8C and FIG. 10C). After that, the container 20 moves to the front of the display device 30 without rotating.

Note that in the above-mentioned second exemplary embodiment, description has been given with regard to an example in which the right-hand-side upper guide 352 is provided with the plural roll-shaped members 39 (see FIG. 5); however, the right-hand-side upper guide 352 in the first exemplary embodiment and the right-hand-side upper guide 352 in the third exemplary embodiment may be also provided with the roll-shaped members 39.

Also, in the above-mentioned first to third exemplary embodiments, the container 20 has been described as being made of resin by way of example; however, the above-described function may be imparted to a container made of metal, such as a two-piece can and a three-piece can, for example.

Also, although the projecting portion 24 in the first exemplary embodiment, the first projecting portion 211 and the second projecting portion 212 in the second exemplary embodiment are integrally formed with the container body 21, another component, for example, may be attached to the container body 21 thereby to form the projecting portion 24 or each of the first projecting portion 211 and the second projecting portion 212.

Also, in the above description, the film 29 having the identification marks 23 printed thereon is wrapped around the container 20 thereby to form the identification marks 23 on the container 20; however, printing or the like may be performed directly on the container 20 thereby to form the identification marks 23.

Further, in the first to third exemplary embodiments, the placement unit 31 is formed in flat form; however, the placement unit 31 may be provided for example with plural roll-shaped members 39 such as are shown in FIG. 5.

Further, in the first to third exemplary embodiments, the identification mark 23 is made to face frontward while the container 20 is in course of frontward movement; however, the identification mark 23 may be made to face toward the front side, for example while the container 20 is in course of backward or lateral movement. For example, in a display device in which the container 20 is supplied at the front side and this container is turned around at the back side to move back to the front side again, the identification mark 23 may be made to face toward the front side while the container 20 is in course of movement toward the back side. Then, the container 20 is turned around while keeping itself as it is (keeping its position), thereby to display the container 20 with the identification mark 23 facing frontward.

Also, in the above-mentioned first to third exemplary embodiments, description has been given with regard to an example in which the upper guide 35 is arranged extending above the taken-out portion for the containers 20; however, a configuration such as is shown in FIG. 11 may be adopted.

Here, FIG. 11 is a view showing a modified example of the display device 30.

As shown in FIG. 11, a configuration may be such that the upper guide 35 is arranged extending from the supplying portion for the containers 20 to a predetermined position and no upper guide 35 is provided above the taken-out portion. This instance facilitates taking out the containers 20, as compared to an instance where the upper guide 35 is provided extending to the taken-out portion for the containers 20.

Also, rotation of the container 20 may be accomplished by use of the cap 22.

FIG. 12 is a view showing another configuration of the display device 30. In FIG. 12, description will be given by taking a case where the container 20 shown in FIGS. 3A and 3B is used, as an example.

The display device 30 shown in FIG. 12 is provided with a projecting member 40 that has a contact face 40a coming into contact with an outer circumferential face of the cap 22, and that projects downward from the supporting frame (not shown in the figure).

Here, the cap 22 includes convex portions each provided on the outer circumferential face thereof and arranged extending in a height direction of the cap 22, and concave portions each provided in the outer circumferential face and likewise arranged extending in the height direction. The plural convex portions and concave portions are provided and are also arranged alternating with each other in a circumferential direction of the cap 22.

Also, the contact face 40a of the projecting member 40 likewise has plural convex portions and concave portions formed thereon and therein, respectively. The convex portions and the concave portions are provided extending in the top-bottom direction, and are also arranged alternating with each other in the front-back direction of the display device 30.

In this exemplary embodiment, then, when the cap 22 is in contact with the contact face 40a, concavities and convexities formed in and on the outer circumferential face of the cap 22 engage concavities and convexities formed in and on the contact face 40a. As a result, the container 20 is restricted in its movement on the left-hand side thereof, and thus, the container 20 makes rotation such as is shown by the arrow 12A. Then, the container 20 falls down, for example when the second identification mark 23b faces toward the front of the display device 30.

Here, in this exemplary embodiment, separation of the cap 22 from the contact face 40a does not permit application of rotational force to the container 20. In this exemplary embodiment, therefore, there is provided a prevention member 41 that comes into contact with a side portion of the container 20 thereby to limit sideward movement of the container 20 and thus prevent separation of the contact face 40a and the cap 22. The prevention member 41 is configured as a rotatable roll-shaped member so as not to impede the container 20 from moving frontward.

Note that in FIG. 12, the prevention member 41 is used to maintain contact of the contact face 40a with the cap 22; however, maintenance of the contact may be achieved for example by the right-hand-side upper guide 352 having a longer length than its length shown in FIG. 12. Alternatively, the maintenance of the contact may be achieved for example by arranging slopingly the left-hand-side upper guide 351 and the right-hand-side upper guide 352 in order for the container 20 to lean to the left.

Also, in this exemplary embodiment, the contact face 40a is provided with the concavities and convexities; however, a rubber member such as EPDM (ethylene-propylene rubber) may be attached to the contact face 40a, as in the case of the configuration shown in FIGS. 2A and 2B.

### Fourth Exemplary Embodiment

Description will now be given with regard to the fourth exemplary embodiment.

FIG. 13 (FIGS. 13A to 13C) is a view illustrating the fourth exemplary embodiment. A method here shown is such that, at the time when the container 20 faces a given direction, the container 20 does not fall down but continues its movement, as it is, by the next movement unit. FIG. 13A is a view of the first movement unit that moves the container 20 while causing rotation thereof, as seen from the front side. The upper guide 35 fixed at one end to the supporting portion 37 extending downward from above is provided above the placement unit 31. The left-hand-side upper guide 351 of the upper guide 35 is provided partially at the upper left thereof with a rotation application portion 141 including a guide projecting portion 41a. The container 20 includes the projecting portion 24 that has protrusions 341 of concavities and convexities at positions corresponding to the first identification mark 23a and the second identification mark 23b, as shown in FIG. 13C. The protrusions 341 protrude in a form extending out from the circumference of the projecting portion 24. The upper guide 35 is attached to a part of the placement unit 31 in a direction of travel of the containers, with the same slope as the placement unit 31. A top face of the upper guide 35 does not come into contact with a bottom face of the projecting portion 24 of the container 20 since the relative positions of the top face and the bottom face are such that the top face is positioned slightly below the bottom face. Therefore, the upper guide 35 serves a function of regulating rightward and leftward movement of the container 20. When the container 20, which moves on the placement unit 31, passes a part where the upper guide 35 is provided, the container 20 rotates while moving with the protrusions 341 of the projecting portion 24 of the container 20 in engagement with the guide projecting portion 41a of the rotation application portion 141 provided on the left-hand-side upper guide 351, as shown in FIG. 13B. At the completion of engagement of all the protrusions 341 of the projecting portion 24, a circular part of the projecting portion 24 comes into contact with the guide projecting portion 41a, and thus, the container 20 stops rotating and moves frontward while keeping itself as it is. At the time when the upper guide 35 ends, the container 20 further moves frontward while keeping its position.

### Fifth Exemplary Embodiment

The fifth exemplary embodiment of the present invention will be described below with reference to the accompanying drawings.

FIG. 14 (FIGS. 14A and 14B) is a view showing a schematic configuration of the display device according to the fifth exemplary embodiment. FIG. 15 is a view of the display device 30 and the container 20 when seen from the front side thereof.

As shown in FIG. 14A, the display device 30 according to this exemplary embodiment has the same configuration as described above, and includes: the placement unit 31 on which the containers 20 formed as a can body and filled with drink therein are to be placed; and the guides 32 that form a movement route of the containers 20, and that guide movement of the containers 20. The display device 30 also includes the regulation plate 34 that is formed transparently, arranged along one side of the placement unit 31 and that stops the movement of the containers 20.

The display device 30 is, as shown in FIG. 14B, put inside the display case 10 installed in a convenience store, a super market or the like, as in the case of the above. This display case 10 includes: the case main body unit 10A formed into a rectangular parallelepiped shape; and the doors 10B provided so as to be openable and closable with respect to this case main body unit 10A, which form the main part of the display case 10, as in the case of the above.

Here, the display device 30 is placed on a shelf (not shown in the figure) provided to the display case 10. On this occasion, the display device 30 is placed so that the side thereof where the regulation plate 34 is provided is located at the side where the doors 10B are provided. Additionally, the placement unit 31 is arranged so that the side thereof where the regulation plate 34 is provided is positioned at a lower level than a side thereof opposite to the side where the regulation plate 34 is provided. That is, the placement unit 31 is arranged in the downward sloping state from the back side of the display case 10 toward the front side thereof (the side of the taken-out portion) from which the containers 20 are taken out.

Here, the display case 10 in this exemplary embodiment also has a door (not shown in the figure) provided on the back side thereof, as in the case of the above, whereby the back side becomes also openable. The containers 20 are supplied to the display device 30 from this back side. That is, the display case 10 has a configuration where the supplying portion for the containers 20 is provided at the back side of the display case 10, and at the back side of the display device 30. The containers 20 having been supplied move on the placement unit 31 toward the side of the doors 10B. That is, the containers 20 having been supplied move toward purchasers who purchase the containers 20. Note that, in this description of the invention, the side where the doors 10B are provided is sometimes referred to as a front side (frontward), whereas the side opposite to the doors 10B is sometimes referred to as a back side (backward). The width direction (a direction orthogonal to a direction in which the containers 20 move) of the display case 10 is sometimes referred to as a lateral direction, or as a width direction.

Description will be given with regard to the display device 30 in more detail.

FIG. 16 (FIGS. 16A and 16B) is a top view of the display device 30.

The guides 32 of the display device 30 according to this exemplary embodiment are arranged along the movement route of the containers 20. Also, the guides 32 are provided respectively on both sides of the movement route of the containers 20. Here, the guides 32 are made of, for example, a metallic material such as aluminum, a resin material, or the like.

The placement unit 31 that functions as the movement unit is arranged as sloped in the width direction. Specifically, the sloped arrangement is such that one guide 32 (the guide 32 on the left-hand side in the drawing) side is positioned lower than the other guide 32 (the guide 32 on the right-hand side in the drawing) side. Also, the placement unit 31 is slopingly arranged so that the front side thereof is positioned lower than the back side thereof, as mentioned above. Here, the reference numerals 2A and 2B in FIGS. 16A and 16B represent how the placement unit 31 slopes. Also, “ZB” and “ZH” in FIGS. 16A and 16B indicate sloping angles of the placement unit 31. In this description, hereinafter, the guide 32 on the left-hand side and the guide 32 on the right-hand side will be sometimes referred to as the left-hand-side guide 32 and the right-hand-side guide 32, respectively.

Further, the placement unit 31 includes a first roller group 311, a second roller group 312, and a third roller group 313 arranged side by side in the width direction of the placement unit 31, on a surface thereof on which the containers 20 are to be placed. Here, each of the roller groups includes plural roll-shaped members 314 that are rotatable in the movement direction of the containers 20 and arrayed in the front-back direction. The first roller group 311 is arranged on the left-hand-side guide 32 side, the third roller group 313 is arranged on the right-hand side-guide 32 side, and the second roller group 312 is arranged between the first roller group 311 and the third roller group 313.

Further, in this exemplary embodiment, the left-hand-side guide 32 is provided with a resistance application portion 33 that applies sliding resistance (frictional resistance) to the containers 20 coming into contact with the left-hand-side guide 32. The resistance application portion 33 in FIG. 16A is provided over the overall length in the movement direction, whereas the resistance application portion 33 in FIG. 16B is provided partially over the length in the movement direction. Here, preferably, the resistance application portion 33 in this exemplary embodiment is circular in cross section because a contact area and does not always change significantly with respect to up and down movement as well as right and left sloping of the containers 20. For example, vinyl tape made of vinyl chloride or the like, or a rubber member such as EPDM (ethylene-propylene rubber) may be attached to a bar member circular in cross section as a shaft, thereby to form the resistance application portion 33. Also, the resistance application portion 33 may be made of a resin material. The resistance application portion 33 made of the vinyl tape or the like has a function of increasing resistance force applied to the containers 20 through the left-hand-side guide 32, and may be considered as a resistance force increasing member.

The container 20 will now be described in detail.

A first configuration of the container 20 is such that a friction coefficient between a first contact portion of the container 20 and the guide 32 is relatively larger than a friction coefficient between a second contact portion of the container 20 and the guide 32, so that the container 20 automatically faces a predetermined direction in a predetermined position.

FIG. 17 (FIGS. 17A to 17D) is a view for explaining the container 20.

FIG. 17A shows the container 20 as viewed from one side, and FIG. 17B shows the container 20 as viewed from the other side. Also, FIG. 17C shows a cross section of a portion S in FIG. 17A, and FIG. 17D shows a cross section of a portion T in FIG. 17A.

The container 20 shown in FIGS. 17A to 17D is what is called a two-piece can, and is filled with a content such as drink and has a lid member having a pull tab (not shown in the figure), attached thereto.

As shown in FIGS. 17A and 17B, the container 20 includes first to fourth regions R1 to R4 on the outer circumferential face. Here, these regions are provided in order of the first region R1, the second region R2, the third region R3 and the fourth region R4 in the circumferential direction of the container 20. A surface state of the first region R1 and a surface state of the third region R3 are configured in the same manner. Also, a surface state of the second region R2 and a surface state of the fourth region R4 are configured in the same manner. Thus, hereinafter, description will be given centering on the first region R1 and the second region R2. Further, in this exemplary embodiment, a friction coefficient at the surface is such that the first region R1 (the third region R3)>the second region R2 (the fourth region R4).

Firstly, description will now be given with regard to the surface state of the second region R2 with reference to FIG. 17C.

As shown in FIG. 17C, in the second region R2, an ink layer 51 is provided on the surface of a container body 50. Also, a topcoat layer (an outermost layer) 52 having concavities and convexities in crater form is provided on the surface of the ink layer 51.

Here, ink for use in metal printing, for example, may be used as ink for use in the ink layer 51. Here, various organic pigments or inorganic pigments may be used as pigment (color quantity) of the ink. Also, a vehicle of the ink contains a resin such as a thermosetting resin or an ultraviolet-curing resin, as a main ingredient. Here, an alkyd type or polyester type resin or the like is used as the thermosetting resin. Also, an ultraviolet radical polymerization type or ultraviolet cationic polymerization type resin or the like is used as the ultraviolet-curing resin. Further, the ink may contain an additive. A matting agent, wax (natural wax, petroleum wax, or synthetic wax), a desiccant, a dispersant, a wetting agent, a crosslinking agent, a gelling agent, a puffing agent, an anti-skinning agent, a stabilizer, an anti-foaming agent, a photopolymerization initiator, or the like is used as the additive.

Also, the ink layer 51 is made of what is called repellent ink. Specifically, the ink layer 51 is made of ink that repels a coating material when the coating material to form the topcoat layer 52 is applied to the surface of the ink layer 51. Here, the coating material to form the topcoat layer 52 is repelled by the ink layer 51 thereby to form the above-mentioned concavities and convexities of the topcoat layer 52.

In order that the coating material to form the topcoat layer 52 is repelled by the ink layer 51 (in order that the above-mentioned concavities and convexities are formed), it is desirable that surface tension of the ink used to form the ink layer 51 be set lower than surface tension of the coating material used to form the topcoat layer 52, by 5 mN/m or more. In other words, it is desirable that the surface tension of the ink be lower than the surface tension of the coating material and a difference in surface tension between the ink and the coating material be 5 mN/m or more. Here, a reduction in the surface tension of the ink may be accomplished for example by adding silicone to typical ink.

Meanwhile, the coating material for use in the topcoat layer 52 contains a resin such as a thermosetting resin or an ultraviolet-curing resin, as a main ingredient, and contains a wax component as needed.

A phenol-formaldehyde resin, a furan-formaldehyde resin, a xylene-formaldehyde resin, a ketone-formaldehyde resin, an amino resin, a urea formaldehyde resin, a melamine-formaldehyde resin, an alkyd resin, an unsaturated polyester resin, an epoxy resin (e.g., a novolak type epoxy resin or a bisphenol type epoxy resin), a bismaleimide resin, a triallyl cyanurate resin, a thermosetting acrylic resin, a silicone resin, an oil-based resin, or the like is used as the thermosetting resin.

Further, a compound of a thermosetting resin and a thermoplastic resin may be used. In this case, a vinyl chloride-maleic acid-vinyl acetate copolymer, an acrylic polymer, a saturated polyester resin, or the like is used as the thermoplastic resin. These resins may be used singly, or two or more resins may be used in combination. Also, these resin compounds may have a known acid catalyst, such as toluenesulfonic acid or benzenesulfonic acid, added thereto as needed. When the acid catalysis is used, it is desirable that 0.5 to 1 wt % of acid catalyst be added to the resin. Also, of these resins, it is desirable that a compound of a melamine-formaldehyde resin and a saturated polyester resin or a compound of a thermosetting acrylic resin and a melamine-formaldehyde resin, in particular, be used in terms of coating film performance.

Meanwhile, a cation cure resin, a radical cure resin, or the like, for example, is used as the ultraviolet-curing resin. A compound of an ultraviolet-curing epoxy resin and a photo-cationic polymerization catalyst, or the like is used as the cation cure resin.

Also, the coating material for use in the topcoat layer 52 may contain a crosslinking agent or a sensitizing agent added to the above-mentioned resin as needed. Various polyols (e.g., •-caprolactamtriol) or the like is used as the crosslinking agent. A thioxanthone derivative or the like is used as the sensitizing agent.

Further, natural, petroleum and synthetic waxing compounds may be added as a wax component singly or in combination to the coating material for use in the topcoat layer 52, in order to assist in sliding.

Furthermore, various silicone oils may be added as a leveling agent for the surface of the topcoat layer 52, and/or for the purpose of improving stability in a coated state or imparting initial sliding properties to the topcoat layer 52.

Note that an example of composition and the like of the ink layer 51 and the topcoat layer 52 is listed as follows.

<Topcoat layer 52>

Resin component: polyester 30%, acrylic 13%, amino 55%, epoxy 2%

Wax: petroleum 0.3%, natural 1%, synthetic 0.2% (with respect to resin component)

Silicone oil (mixed): 0.15% (with respect to resin component)

Surface tension: 33 mN/m

Thickness: 5 •m

<Ink layer 51>(repellent ink)

Main resin: alkyd resin

Pigment: TiO₂

Surface tension: 28 mN/m

Thickness: 2 •m

Note that the above is description of an example of a method for forming the second region R2, and a technique disclosed in Japanese Patent Application Laid Open Publication No. 2002-361172, for example, may be used to form the second region R2. That is, concavities and convexities may be formed by aggregating the coating material to form the topcoat layer 52 on the surface of the ink layer 51 in the form of spots, thereby to form the second region R2.

The concavities and convexities of the above-mentioned second region R2 formed by a coating material in this exemplary embodiment are of the order of about 3 to 10 •m at maximum depth. In the case of a typical coating material, a smooth surface having a depth of about 1 •mm or less is called the first region R1.

Description will now be given with regard to the surface state of the first region R1 with reference to FIG. 17D.

As shown in FIG. 17D, in the first region R1, the ink layer 51 is provided on the surface of the container body 50, as in the case of the above. Also, the topcoat layer (outermost layer) 52 whose surface is formed more smoothly than the topcoat layer 52 in the above-mentioned second region R2 is provided on the surface of the ink layer 51.

Here, the ink layer 51 in the first region R1 is formed by using ink (typical ink) that does not repel the coating material to form the topcoat layer 52. As mentioned in addition, ink whose surface tension is equal to or higher than the surface tension of the coating material to form the topcoat layer 52 is used as the ink to form the ink layer 51. Thus, in the first region R1, the coating material to form the topcoat layer 52 is not repelled, and the surface of the topcoat layer 52 is smooth as compared to the topcoat layer 52 in the second region R2. A basic composition and the like of the ink to form the ink layer 51 is the same as described above. A basic composition and the like of the coating material to form the topcoat layer 52 is the same as described above.

Also, the container 20 according to this exemplary embodiment has the first identification mark 23a and the second identification mark 23b for differentiating the container 20 from other products, such as a trade name or a trademark, on the outer face (the outer circumferential face) thereof, as in the case of the above (note that in this description, these marks will be referred to simply as the “identification marks 23” in some cases). Here, the first identification mark 23a is formed in the first region R1, while the second identification mark 23b is formed in the third region R3. The first identification mark 23a and the second identification mark 23b are formed by the above-mentioned ink layer 51. Also, in FIGS. 17A to 17D, there is shown an example where the first identification mark 23a and the second identification mark 23b are different; however, these marks may have the same configuration.

Description will now be given with regard to behavior of the container 20 in the display device 30.

FIG. 18 (FIGS. 18A and 18B) is a view for explaining the behavior of the container 20 in the display device 30.

When the container 20 is placed at the back of the placement unit 31 (see the reference numeral 4A), the container 20 moves frontward while being guided by the left-hand-side guide 32. Then, at this time, if the first region R1 is in contact with the resistance application portion 33, sliding between the first region R1 and the resistance application portion 33 is suppressed (resistance force is applied to the first region R1), and the container 20 thus moves frontward while making clockwise rotation (see the reference numeral 4B).

Then, as indicated by the reference numeral 4C, when the second region R2 comes into contact with the resistance application portion 33, sliding occurs between the second region R2 and the resistance application portion 33, and the container 20 thus stops rotating. After that, the container 20 moves (slides) frontward while being guided by the left-hand-side guide 32. Thereby, the container 20 that has reached the front of the display device 30 is in a state such that the second identification mark 23b faces frontward. As mentioned in addition, in this exemplary embodiment, the second region R2 and the second identification mark 23b are arranged so as to have a predetermined positional relationship. More specifically, the second region R2 and the second identification mark 23b are arranged so that, when the second region R2 faces leftward (one direction), the second identification mark 23b faces frontward (a direction intersecting with the one direction, or equivalently, a direction orthogonal to the one direction). Thus, when the second region R2 is in contact with the resistance application portion 33, the second identification mark 23b faces frontward.

Here, the first region R1 may be considered as a first contact portion that comes into contact with the left-hand-side guide 32 when the second identification mark 23b faces a direction other than frontward (a direction other than a specific direction), that rotates the container 20 (the container body), and that makes the second identification mark 23b face frontward (the specific direction). Also, the second region R2 may be considered as a second contact portion that comes into contact with the left-hand-side guide 32 when the second identification mark 23b faces frontward (the given direction), and that slides the container 20 (the container body) with respect to the left-hand-side guide 32.

Illustration of the first roller group 311, the second roller group 312, and the third roller group 313 (see FIGS. 16A and 16B) is omitted from FIGS. 18A and 18B. Here, when the second region R2 comes into contact with the resistance application portion 33, the second region R2 and the resistance application portion 33 are nearly in point contact with each other. As mentioned in addition, the second region R2 and the resistance application portion 33 are in a state where a contact area decreases. It is conceivable that the above-mentioned sliding thus occurs between the second region R2 and the resistance application portion 33.

After the identification mark 23 faces frontward, it is preferable that sliding resistance applied from the left-hand-side guide 32 to the container 20 be minimized. Therefore, rather than a configuration in which the resistance application portion 33 is provided over the overall length as shown in FIG. 18A, a configuration is preferably such that the resistance application portion 33 is arranged halfway along the movement route of the container 20, and the resistance application portion 33 is not provided from a predetermined position to the taken-out portion for the container 20, as shown in FIG. 18B. In other words, a configuration is preferably such that the resistance application portion 33 is provided on a part of a region of the left-hand-side guide 32, not over the overall length of the left-hand-side guide 32.

Also, in this exemplary embodiment, the placement unit 31 is given a slope in the width direction; however, the placement unit 31 may be configured so that it is not given the slope in the width direction, for example, at a part more frontward than the resistance application portion 33. Also in this case, the sliding resistance acting on the container 20 from the left-hand-side guide 32 decreases, and rotation of the container 20 thus becomes difficult.

Also, in the above description, the placement unit 31 is given a slope in the width direction thereby to bring the container 20 into contact with the resistance application portion 33; however, even if the slope in the width direction is not given, the container 20 may be brought into contact with the resistance application portion 33. For example, a biasing member such as a plate spring may be provided on the right-hand-side guide 32 side and be used to bring the container 20 into contact with the resistance application portion 33.

Here, a method for forming the first to fourth regions R1 to R4 will be more specifically described. The first to fourth regions R1 to R4 may be formed in a printing process included in a manufacturing process for the container 20 as a two-piece can, for example. More specifically, the first to fourth regions R1 to R4 may be formed by use of a printing machine installed in the printing process.

Here, FIG. 19 is a view showing a printing machine that performs printing on the container 20.

A printing machine 500 shown in FIG. 19 is a printing machine that performs what is called offset printing. The printing machine 500 includes: a blanket cylinder 510; an ink application apparatus 520 that has a printing plate corresponding to a pattern and that applies, to the blanket cylinder 510, the ink to form the above-mentioned ink layer 51; a supporting roll 530; and a coating application apparatus 540 that applies the coating material to form the above-mentioned topcoat layer 52.

The blanket cylinder 510 is formed into a disc shape, and rotates in one direction. Also, the blanket cylinder 510 has plural blankets (transfer target portions) 511 on its outer circumferential face. Also, the blanket cylinder 510 transfers the ink having been transferred from the above-mentioned printing plate of the ink application apparatus 520 to the blankets 511, to a raw can body as a base body of the two-piece can, at a transfer portion T, and thereby forms a pattern containing the above-mentioned identification mark 23 on the raw can body.

Plural ink application apparatuses 520 are provided respectively for different colors in the circumferential direction of the blanket cylinder 510. Each ink application apparatus 520 includes: a printing cylinder 522 that comes into contact with the blankets 511 of the blanket cylinder 510; and an ink supplying apparatus 521 that supplies ink to the outer circumferential face of the printing cylinder 522. Here, the printing cylinder 522 has the above-mentioned printing plate on its outer circumferential face, and transfers the ink supplied by the ink supplying apparatus 521, to the blankets

Thereby, the ink is put on the surface of each blanket 511. Specifically, the printing cylinders 522 sequentially put their inks respectively on regions provided on the surface of each blanket 511 and assigned respectively to the printing cylinders 522. As a result, an ink image corresponding to the pattern is formed on the surface of each blanket 511. Then, the ink image moves to the transfer portion T along with rotation of the blanket cylinder 510, and is transferred to the outer circumferential face of the raw can body rotating in the circumferential direction. Thereby, the above-mentioned ink layer 51 is formed.

The supporting roll 530 is arranged in such a position to face the blanket cylinder 510, and rotates in one direction to transport the raw can body moved from a not-shown washer process, to the above-mentioned transfer portion T. Also, the supporting roll 530 transports the raw can body to the above-mentioned transfer portion T, while rotating the raw can body moved from the washer process.

The coating application apparatus 540 applies a coating material to the outer circumferential face of the raw can body having the above-mentioned ink image transferred thereto (the raw can body having the ink layer 51 formed thereon). Thereby, the above-mentioned topcoat layer 52 is formed.

Here, when such a printing machine 500 is used, the ink having the function of repelling the coating material is put on the blankets 511 by the printing cylinder 522 in charge of the ink layer 51 in the above-mentioned second region R2, and thereby, a difference in surface between the second region R2, and the first region R1 and the third region R3 adjacent to the second region R2 may be produced.

Incidentally, the common (one) printing cylinder 522 typically supplies the ink to portions of the same color on the outer circumferential face of the container 20. However, in this exemplary embodiment, even if the first to fourth regions R1 to R4 have portions of the same color, the ink is supplied from different printing cylinders 522. Specifically, one printing cylinder 522 supplies the ink to portions of the same color in the first region R1 and the third region R3, while another printing cylinder 522 (or the printing cylinder 522 that supplies repellent ink) different from the one printing cylinder 522 supplies the ink to portions of the same color in the second region R2 and the fourth region R4.

Also, if a pattern using plural colors is present over a wide range along the overall circumference of the container 20, it is required that many printing cylinders 522 be prepared, as compared to typical printing. Specifically, it is required that plural printing cylinders 522 be first prepared, in order to form a pattern in the first region R1 and the third region R3, for example. Then, it is required that plural printing cylinders 522 be additionally prepared, in order to form a pattern in the second region R2 and the fourth region R4.

Here, a configuration such as is shown in FIG. 27 (FIGS. 27A and 27B) (a view showing another exemplary embodiment of the container 20) may be adopted in order to prevent an increase in the number of printing cylinders 522 as mentioned above. FIG. 27A is a front elevational view of the container 20, and FIG. 27B is a rear elevational view of the container 20.

As shown in FIGS. 27A and 27B, for example, the second region R2 and the fourth region R4 may be provided on a bottom portion side of the container 20. More specifically, each of the second region R2 and the fourth region R4 may be formed as a band extending in the circumferential direction of the container 20 and having a slightly larger width than the width of the resistance application portion 33. As described even more specifically, the second region R2 and the fourth region R4 may be such that their lengths in the circumferential direction of the container 20 are each ¼ of the circumferential length of the container 20. With such a configuration, even if a pattern using plural colors is present along the overall circumference of the container 20, only one printing cylinder 522 for formation of the second region R2 and the fourth region R4 has to be added. As mentioned in addition, this configuration eliminates the need to prepare a large number of printing cylinders 522 as mentioned above. The raw can body subjected to application of a coating material by the coating application apparatus 540 is then heated at 200 to 220 degrees C. in an oven process (a heating process).

Note that in the above description, what is called the repellent ink is used to form the concavities and convexities in and on the second region R2; however, what is called foaming ink containing a foaming agent, for example, may be used to form the ink layer 51 and thus form the concavities and convexities in and on the second region R2.

Also, in the above description, the second region R2 is provided with the concavities and convexities thereby to reduce the sliding resistance; however, a fluorocarbon resin or the like may be attached or applied to the second region R2 to reduce the sliding resistance. In this case, a reduction in the sliding resistance is easier with attachment of tape or the like coated with Teflon (a registered trademark). Likewise, a fluorocarbon-based resin (PTFE, PFA, PVDF, or the like) and tape thereof, or film tape having low frictional resistance such as an ultra high molecular weight polyethylene film may be used.

Further, what is called matte coating may be used as the coating material to form the topcoat layer 52 in the second region R2 thereby to provide the second region R2 with the concavities and convexities and thus reduce the sliding resistance. In this case, different coating materials need to be applied to the respective regions. Specifically, it is required to apply matte coating to the second region R2, and to apply a coating material other than the matte coating to the first region R1.

Also, matte coating may be further applied to the surface of the topcoat layer 52 in the second region R2 thereby to provide the second region R2 with the concavities and convexities and thus reduce the sliding resistance in this region.

Also, repellent ink may be used to form the ink layer 51 in the second region R2, and matte coating may be used to form the topcoat layer 52 on the surface of the ink layer 51.

Here, the matte coating refers to a coating material that contains particles scattering light, such as glass, silica or resin, and that reduces glossiness as compared with a typical coating material. The matte coating has concavities and convexities formed in and on the surface thereof, because of containing the particles of glass, silica, resin or the like as mentioned above. Thus, the use of the matte coating also enables reducing the frictional resistance between the left-hand-side guide 32 and the second region R2, thus leading to the occurrence of sliding as mentioned above.

Also, for example, after the formation of the topcoat layer 52 in the first to fourth regions R1 to R4 using the matte coating, a coating material for making the surface smooth (for example, a coating material not containing the above-mentioned glass or the like) may be applied to the first region R1 and the third region R3. In other words, after the matte coating is applied so that the overall circumference of the container 20 is easy to slide, the coating material for making the surface smooth may be applied to the first region R1 and the third region R3 so that the first region R1 and the third region R3 are difficult to slide.

Also, for example, after the formation of the topcoat layer 52 in the first to fourth regions R1 to R4 using the matte coating, for example the above-cited Teflon (the registered trademark)-based tape or sticker or the like having a lower friction coefficient than that of the topcoat layer 52 may be attached to the second region R2 and the fourth region R4.

Here, the present inventors performed the following experiments in order to examine optimum conditions for the display device 30 and the container 20.

Here, FIG. 20 (FIGS. 20A and 20B) is a view showing experimental conditions for measurement of static friction coefficients between the surfaces of various cans and resistance materials, and a table showing experimental results.

An experimental instrument 700 shown in FIG. 20A was used to perform the experiment. FIG. 20A shows side and top views of the experimental instrument 700. Also, FIG. 20B is the table showing the experimental results.

As shown in FIG. 20A, the experimental instrument 700 was provided with a moving plate 710 arranged so as to slope with respect to a horizontal plane H and allowed to change sloping angles Z with respect to the horizontal plane H. Also, a top surface of the moving plate 710 was provided with a base material 720 formed into a flat-plate shape and forming the container 20 (the raw can body). The above-mentioned ink layer 51 and topcoat layer 52 were formed on the surface of the base material 720.

Further, a test piece 730 was mounted on a top surface of the base material 720. The test piece 730 had bottom dimensions of 35×70 mm and a weight of 120 g. Also, the test piece 730 had a test material 740 attached to a surface on the base material 720 side. Then, by increasing the sloping angle Z of the moving plate 710 with the test piece 730 mounted on the base material 720, the present inventors examined the sloping angle Z at which sliding of the test piece 730 started.

Numerical values in FIG. 20B are not the actual sloping angles Z but are numerical values as tan Z. Also, the numerical values in FIG. 20B represent the ranges of average values obtained by preparing two base materials 720 subjected to coating materials to be described later, and performing three tests on each base material 720. Here, a rubber-based, highly-adhesive material varies greatly, because of being in a non-lubricant state. Note that in the display device 30, the container 20 is typically in a still state, and when the container 20 at the front is taken out, the container 20 starts frontward movement. In other words, in the actual display device 30, the container 20 repeats stopping and movement relative to the resistance application portion 33. As mentioned in addition, in the actual display device 30, static friction and dynamic friction occur between the container 20 and the resistance application portion 33. What is shown below is examination performed centering on the static friction; however, it is required to perform a test additionally on the dynamic friction, because the dynamic friction occurs as mentioned above. The present inventors first performed the examination in order to select a material (in order to observe the tendency of each material).

Here, a base material including the ink layer 51 made of typical ink and the topcoat layer 52 made of a typical coating material was prepared as the base material 720. Also, a base material including the ink layer 51 made of repellent ink and the topcoat layer 52 made of matte coating was prepared as the base material 720. Further, a base material including the ink layer 51 made of repellent ink and the topcoat layer 52 made of a typical coating material was prepared as the base material 720. Also, a base material in which Teflon tape (ASF110 manufactured by Chukoh Chemical Industries, Ltd.) is attached to the surface of the topcoat layer 52 was prepared as the base material 720.

That is, the base materials 720 having the surfaces of “a combination of the typical ink and the typical coating material,” “a combination of the repellent ink and the matte coating,” “a combination of the repellent ink and the typical coating material,” and “the Teflon tape attached thereto” were prepared.

Also, rubber (with a hardness of A60), commercially available vinyl tape made of vinyl chloride, Teflon tape (ASF110 manufactured by Chukoh Chemical Industries, Ltd.), and commercially available self-adhesive tape (autohesion tape) made of butyl rubber were prepared as the test materials 740.

Description will be given with regard to the experimental results with reference to FIG. 20B.

When the rubber is used as the test material 740, a difference in numerical value between “the combination of the typical ink and the typical coating material” and any one of “the combination of the repellent ink and the matte coating” and “the combination of the repellent ink and the typical coating material” might be unclear. However, when the vinyl tape is used as the test material 740, the numerical value of any one of “the combination of the repellent ink and the matte coating” and “the combination of the repellent ink and the typical coating material” is below that of “the combination of the typical ink and the typical coating material.” Also, when any one of the Teflon tape and the self-adhesive tape is used as the test material 740, there is no clear difference.

Thus, the vinyl tape may be adoptable for the resistance application portion 33. Also, the Teflon tape may be used as a means for reducing resistance, because of low numerical values for all the base materials 720. Note that the above is illustrative of examination, and the rubber varies in its properties according to how an additive is added thereto. Thus, the rubber may be used for the resistance application portion 33, depending on the type of rubber.

As may be seen from the above results, sliding is less likely to occur between the left-hand-side guide 32 and the first and third regions R1 and R3, for example when the vinyl tape is attached to the left-hand-side guide 32, “the combination of the typical ink and the typical coating material” is used to form the surfaces of the first region R1 and the third region R3, and any one of “the combination of the repellent ink and the matte coating” and “the combination of the repellent ink and the typical coating material” is used to form the surfaces of the second region R2 and the fourth region R4. Also, sliding is likely to occur between the left-hand-side guide 32 and the second and fourth regions R2 and R4.

Next, the present inventors examined behavior of the container 20 with the container 20 placed in the display device 30, provided that the above conditions capable of making a difference in sliding resistance were provided to the left-hand-side guide 32 and the container 20 filled with a content.

In this examination, the vinyl tape was attached to the entire area of the left-hand-side guide 32, unlike the configuration of the resistance application portion 33 such as is shown in FIG. 16B. Also, the sloping angle ZB (see FIGS. 16A and 16B) of the placement unit 31 in the width direction thereof was set to 3 degrees, and the sloping angle ZH of the placement unit 31 in the front-back direction thereof was set to 4 degrees. Further, the left-hand-side guide 32 and the right-hand-side guide 32 were disposed at a height of 15 mm above the placement unit 31.

Also, a container 20 having the ink layer 51 made of the typical ink and the topcoat layer 52 made of the typical coating material was prepared. A container 20 having the ink layer 51 made of the repellent ink and the topcoat layer 52 made of the matte coating was prepared as well. That is, a container 20 formed of “the combination of the typical ink and the typical coating material” and a container 20 formed of “the combination of the repellent ink and the matte coating” were prepared. Also, plural examinations were performed on the behavior of each container 20 under the same conditions. Further, a container having a capacity of 350 ml was prepared for the container 20. Also, the container 20 was filled with drink and had a lid member attached thereto.

Here, FIG. 21 is a table showing test results.

It has been confirmed that the container 20 formed of “the combination of the typical ink and the typical coating material” rotates undergoing sliding resistance from the left-hand-side guide 32. More specifically, it has been confirmed that the container 20 rotates by 90 degrees when it travels a distance of 110 to 125 mm, and rotates by 180 degrees when it travels a distance of 200 to 250 mm.

On the other hand, it has been confirmed that the container 20 formed of “the combination of the repellent ink and the matte coating” also rotates; however, an angle of rotation thereof was small, and the angle of rotation lay between 30 and 55 degrees when the container 20 traveled a distance of 300 mm. In other words, the container 20 formed of “the combination of the repellent ink and the matte coating” may be restricted in its rotation, as compared to the container 20 formed of “the combination of the typical ink and the typical coating material.”

Here, it is preferable that the angle of rotation of the container 20 formed of “the combination of the repellent ink and the matte coating” be smaller. Therefore, the present inventors fixed every other one of the plural roll-shaped members 314 forming the above-mentioned third roller group 313 (see FIGS. 16A and 16B) so as to prevent its rotation. Then, under this condition, the present inventors performed the same examination as described above.

FIG. 22 is a table showing test results when every other one of the roll-shaped members 314 is fixed.

When every other one of the roll-shaped members 314 is fixed, the angle of rotation of the container 20 formed of “the combination of the repellent ink and the matte coating” may fall within a range of 15 to 25 degrees, as shown in FIG. 22. In other words, the angle of rotation of the container 20 is small as compared to a case where the roll-shaped members 314 are not fixed. When the roll-shaped members 314 are fixed as mentioned above, it is concerned that the container 20 formed of “the combination of the typical ink and the typical coating material” is also restrained in its rotation; however, as shown in FIG. 22, the container 20 may rotate by 90 degrees when it travels a distance of 120 to 150 mm, and may rotate by 180 degrees when it travels a distance of 250 to 300 mm.

Next, the present inventors fixed all the roll-shaped members 314 of the above-mentioned third roller group 313 so as to prevent their rotation, and then performed the same examination as described above. In this examination, the sloping angle ZH of the placement unit 31 in the front-back direction thereof was set to 5 degrees.

FIG. 23 is a table showing test results when all the roll-shaped members 314 are fixed.

When all the roll-shaped members 314 are fixed, the angle of rotation of the container 20 formed of “the combination of the repellent ink and the matte coating” may become 0 degrees, as shown in FIG. 23. Incidentally, also in this case, it is concerned that the container 20 formed of “the combination of the typical ink and the typical coating material” is restrained in its rotation; however, the container 20 formed of “the combination of the typical ink and the typical coating material” may rotate by 90 degrees when it travels a distance of 250 to 310 mm.

Examination on the angle of rotation was performed also on the container 20 formed of “a combination of the typical ink and the matte coating” and the container 20 formed of “a combination of foaming ink and the typical coating material.” As a result, the angle of rotation may become 0 degrees also for these containers 20.

In this examination, the roll-shaped members 314 were fixed to apply resistance to the container 20 on the right-hand side thereof; however, application of resistance to the container 20 on the right-hand side thereof may be accomplished for example by omitting the third roller group 313, or equivalently, by not providing the third roller group 313 and flattening the placement unit 31 in this portion. Alternatively, a member capable of applying resistance (a resistance application member) such as a rubber member, for example, may be provided instead of the third roller group 313. Here, the fixed roll-shaped members 314, the flatly formed placement unit 31, the rubber member, or the like may be considered as a rotation restricting portion that restricts rightward movement of the container 20 (movement thereof toward the other side) and thereby restricts rotation of the container 20.

Also, description has been given above (see FIGS. 17A to 17D) with regard to an example in which the first identification mark 23a and the second identification mark 23b are arranged with their phases shifted 180 degrees in the circumferential direction of the container 20; however, the first identification mark 23a and the second identification mark 23b may be arranged with their phases shifted less than 180 degrees. In this case, then, the first region R1 and the third region R3 are also arranged as shifted corresponding to the positions of the first identification mark 23a and the second identification mark 23b. That is, the first region R1 and the third region R3 are arranged with their phases shifted less than 180 degrees. Then, the second region R2 and the fourth region R4 are arranged between the first region R1 and the third region R3 arranged as shifted in this manner.

Also, in the above description, what is called the two-piece can is illustrated; however, the same function as described above may be imparted to a three-piece can. Also, the same function as described above may be imparted to a container 20 having a film (a label sticker (a shrink film in many cases)) mounted on the outer circumferential face thereof. Examples of such a container 20 include containers such as a PET bottle having a film mounted on the outer circumference and a metal can including a bottle. In such a container 20, as shown for example in FIG. 32, the above-mentioned first to fourth regions R1 to R4 are formed on the film prior to mounting on the container 20, and the film having the first to fourth regions R1 to R4 formed thereon is wrapped around the body of the container 20 thereby to form the container 20. In such a case, the formation of the first to fourth regions R1 to R4 may be accomplished by coating all regions respectively with different coating materials, or by forming only any one of a group of the first region R1 and the third region R3 and a group of the second region R2 and the fourth region R4, with a coating material, utilizing surface frictional resistance of the film itself.

Also, the above-mentioned film mounted on the outer circumferential face of the PET bottle may have outer coating applied to a printed face (or an outer face) so as to impart lubricating properties thereto, in order to prevent clogging from occurring in a vending machine or the like. Therefore, this type of film may be utilized to form regions corresponding to the above-mentioned second region R2 and fourth region R4.

For example, FIG. 28 (FIGS. 28A to 28C) is a view showing another configuration of the container 20. FIG. 28A is a front elevational view; FIG. 28B is a rear elevational view; and FIG. 28C is a bottom view.

The container 20 shown in FIGS. 28A to 28C is what is called a PET bottle, and a film 62 having lubricating properties is mounted on the outer circumferential face thereof. The film 62 is mounted so as to wrap around an outer circumferential face of a body portion 60 of the container 20, and includes a first exposed portion 621 corresponding to the first region R1, below the first identification mark 23a by exposing a part of the outer circumferential face of the body portion 60. Also, the film 62 includes a second exposed portion 622 corresponding to the third region R3, below the second identification mark 23b by exposing a part of the outer circumferential face of the body portion 60.

Here, when the identification mark 23 faces the lateral direction of the display device 30, the first exposed portion 621, for example, comes into contact with the resistance application portion 33, and rotational force is thus applied to the container 20 through the first exposed portion 621. As a result, the second identification mark 23b, for example, comes to face toward the front of the display device 30. On the other hand, when the identification mark 23 faces toward the front of the display device 30, the resistance application portion 33 and the film 62 come into contact with each other, and sliding thus occurs between the resistance application portion 33 and the film 62. Thus, the container 20 moves as far as the front side of the display device 30 with the identification mark 23 facing frontward.

Also, as in the case of the exemplary embodiment in which the above-mentioned coating material is applied to the container body, a shrink film on which different coating materials are respectively applied to the first to fourth regions R1 to R4 may be formed in advance, and the container 20 may be covered with the film, as shown in FIG. 32.

Further, in the above description, the concavities and convexities are formed in and on the second region R2 and the fourth region R4, and the surfaces of the first region R1 and the third region R3 are made smoother than those of the second region R2 and the fourth region R4, whereby the identification mark 23 is made to face frontward. Incidentally, whether or not the container 20 rotates is affected for example by the material forming the topcoat layer 52, or the like. Thus, even if the concavities and convexities are formed in and on the first region R1 and the third region R3, and the second region R2 and the fourth region R4 are smoothly formed, the identification mark 23 may be made to face frontward.

In other words, in this exemplary embodiment, a part where the identification mark 23 is provided is smoothened, and a part where the identification mark 23 is not provided is provided with the concavities and convexities; however, the present invention is not limited to this configuration, and, for example, at least two regions having different friction coefficients may be formed corresponding to the identification marks 23 thereby to allow one of the identification marks 23 to face frontward.

Further, as mentioned previously, the second region R2 and the fourth region R4 may be formed by attaching tape such as Teflon tape having a low friction coefficient to the container 20 at the height of the guide. Conversely, if a material having a low friction coefficient is used for the overall coating, the first region R1 and the third region R3 are formed by attaching resin tape or the like having a high friction coefficient, whereby the same effect may be achieved.

Furthermore, as shown in FIG. 29, prepared in advance is tape obtained by applying a coating material for increasing friction, alternately to positions on for example Teflon tape or the like having a low friction coefficient, the positions corresponding to lengths of four parts into which the circumference of the container is divided in the length direction of the tape. Then, the tape is attached to the container along the overall circumference thereof in alignment with the identification marks 23 of the container 20, whereby the same effect may be provided regardless of the coated state of the container 20.

### Sixth Exemplary Embodiment

Description will now be given with regard to the sixth exemplary embodiment.

A configuration of this exemplary embodiment is such that resistance application between the container 20 and the guide is performed based on their mechanical structures.

FIG. 24 (FIGS. 24A and 24B) is a view showing the display device 30 according to the sixth exemplary embodiment. FIG. 24A is a top view of the display device 30, and FIG. 24B is a view of the display device 30 as seen from the front side.

As shown in FIGS. 24A and 24B, in the display device 30 according to this exemplary embodiment, a second guide 350 extending along the movement route of the containers 20 is provided on the placement unit 31. The second guide 350 includes a first flat portion 35a and a second flat portion 35c formed as flat faces at positions facing the movement route of the containers 20 (at positions where the containers 20 come into contact). Also, the second guide 350 includes a concave and convex portion 35b formed in rack gear form. In this exemplary embodiment, the first flat portion 35a, the concave and convex portion 35b, and the second flat portion 35c are provided from the front side toward the back side of the display device 30. The guide 32 in this exemplary embodiment has a function of preventing the containers 20 from toppling over, and is arranged at a position such that it does not come into contact with the container 20 when the container 20 moves frontward.

Description will now be given with regard to the container 20.

FIG. 25 (FIGS. 25A and 25B) is a view for explaining the container 20. FIG. 25A is a view showing a bottom portion 210 of the container 20, and FIG. 25B is a view showing a cross section taken along the line XXVB-XXVB of FIG. 25A. Also, FIG. 25C is a view showing a cross section taken along the line XXVC-XXVC of FIG. 25A.

The container 20 shown in FIGS. 25A to 25C is what is called a two-piece can, and the bottom portion 210 as a lower portion of the container 20 includes an annular projecting portion 214 projecting in an annular fashion downward of the container 20 (in a direction away from the container 20). Also, the container 20 includes plural projecting portions 213 projecting from an outer circumferential wall of the annular projecting portion 214 (an outer face of the container 20) in a radial direction of the container 20. Here, each of the projecting portions 213 has a width such that the projecting portion 213 may fit between a convex portion 36 (see FIG. 24A) of the above-mentioned concave and convex portion 35b and another convex portion 36 adjacent to the convex portion 36.

Also, the projecting portions 213 are not provided all around the annular projecting portion 214 in a circumferential direction thereof but are arranged on a first region L1 and a third region L3 in the circumferential direction. Here, the first region L1 and the third region L3 are arranged with their phases shifted about 180 degrees in the circumferential direction of the container 20. Also, in the container 20 according to this exemplary embodiment, a second region L2 and a fourth region L4 that are not provided with the projecting portions 213, that is, formed more smoothly than the first region L1 and the third region L3 are provided between the first region L1 and the third region L3.

Also, a side portion 220 of the container 20 has the first identification mark 23a and the second identification mark 23b formed thereon, as in the case of the above.

The second region L2 and the first identification mark 23a are arranged so as to have a predetermined positional relationship. More specifically, the second region L2 and the first identification mark 23a are arranged with their phases shifted 90 degrees in the circumferential direction of the container 20. Also, the fourth region L4 and the second identification mark 23b are likewise arranged so as to have a predetermined positional relationship. More specifically, the fourth region L4 and the second identification mark 23b are arranged with their phases shifted 90 degrees in the circumferential direction of the container 20.

As mentioned in addition, in this exemplary embodiment, the second region L2 and the first identification mark 23a are arranged so that, when the second region L2 faces one direction (upward in the drawing), the first identification mark 23a faces a direction intersecting with the one direction (a direction orthogonal to the one direction, rightward in the drawing).

Also, the fourth region L4 and the second identification mark 23b are arranged so that, when the fourth region L4 faces one direction (downward in the drawing), the second identification mark 23b faces a direction intersecting with the one direction (a direction orthogonal to the one direction, leftward in the drawing).

Description will now be given with regard to behavior of the container 20 in the display device 30.

FIG. 26 (FIGS. 26A and 26B) is a view for explaining the behavior of the container 20 in the display device 30.

As indicated by the reference numeral 8A in FIG. 26A, when the container 20 is placed on the placement unit 31 for example with the second identification mark 23b facing leftward, the container 20 is in a position such that the projecting portions 213 provided on the first region L1 come into contact with the second guide 350. Then, the container 20 slides frontward while keeping that state (see the reference numeral 8B).

Then, when the container 20 reaches the concave and convex portion 35b, the projecting portions 213 on the first region L1 engage the concave and convex portion 35b (the projecting portions 213 and the concave and convex portion 35b are opposed to each other), and the container 20 is thus regulated in its movement on the left-hand side thereof. Thereby, the container 20 moves frontward while rotating clockwise (see the reference numeral 8C). Then, when the second region L2 come to face the second guide 350 in accordance with the rotation of the container 20 (see the reference numeral 8D), the container 20 moves frontward without rotating and with the first identification mark 23a facing frontward. In other words, the container 20 moves toward the taken-out portion for the container 20, with the first identification mark 23a facing frontward.

As indicated by the reference numeral 9A in FIG. 26B, when the container 20 is placed for example with the first identification mark 23a facing frontward, the second guide 350 and the second region L2 face each other. Then, in this case, sliding occurs between the second guide 350 and the annular projecting portion 214, and the container 20 moves frontward without rotating, or if any, with a small angle of rotation (see the reference numeral 9B). Then, also in this case, the first identification mark 23a faces frontward.

Here, the region where the projecting portions 213 are provided may be considered as a first contact portion that, when the identification mark 23 faces a direction other than frontward (a direction other than a specific direction), comes into contact with the second guide 350 thereby to make the identification mark 23 face frontward (the specific direction).

Also, the region where the projecting portions 213 are not provided may be considered as a second contact portion that, when the identification mark 23 faces frontward (the specific direction), comes into contact with the second guide 350 thereby to slide the container 20 (the container body) with respect to the second guide 350.

Although in this exemplary embodiment, the bottom portion 210 (an outer side face of the annular projecting portion 214) is provided with the projecting portions 213, the projecting portions 213 may be formed on the side portion 220 (see FIG. 25A) of the container 20. However, it is preferable that the bottom portion 210 be provided with the projecting portions 213 from the viewpoint of prevention of detraction from external appearance, or the like. Also, it is preferable that a coating material containing a fluorocarbon resin be applied for example to the second guide 350, or Teflon-coated tape be attached thereto, in order to restrict rotation of the container 20 when the identification mark 23 faces frontward.

Further, in this exemplary embodiment, a mold for forming a dome portion of the container 20 (a two-piece can) is provided with a portion based on the shape of the projecting portions 213, and the mold is used to form the projecting portions 213. In other words, in this exemplary embodiment, the projecting portions 213 are formed so that the body portion of the container 20 is integral with the projecting portions 213. Incidentally, a molten resin or the like, for example, may be caused to adhere and then cured thereby to form the projecting portions 213. Alternatively, other members such as resin pieces or metal pieces may be attached by way of bonding or the like, to form the projecting portions 213. Also, in this exemplary embodiment, the two-piece can is illustrated as the container 20; however, the same configuration as described above may be provided for example to a container made of resin, such as a PET bottle, or a container made of glass, ceramics, or the like.

Also, in the above description, the placement unit 31 is sloped in its width direction thereby to bring the container 20 into contact with the second guide 350; however, even if the placement unit 31 is not sloped in its width direction, the container 20 may be brought into contact with the second guide 350. For example, a biasing member such as a plate spring may be provided on the right-hand-side guide 32 side and be used to bring the container 20 into contact with the second guide 350. It is more preferable that the biasing member be provided only at such a position to face the concave and convex portion 35b of the second guide 350.

The above descriptions all give an example in which the container body is provided with the first to fourth regions R1 to R4; however, as shown in FIG. 30, the container body is provided with no particular region. Instead, a mounting member 600 to be mounted on the container body is provided with the above-mentioned regions, and is mounted in alignment with the positions of the marks. In this way, the same effect may be achieved, and moreover, the container body is simple because of requiring no particular configuration. In this case, it is preferable that the mounting member 600 be mounted on the bottom portion of the container from the viewpoint of a position to impart stable rotation to the container 20, and an mountable position on the container 20.

Also, it is preferable that a material for the mounting member 600 be any one of a material having low sliding resistance in a bottom portion, a metallic or resin material having somewhat low friction, and a material in which a bottom portion is dome-shaped thereby to reduce a contact area, or a material including one or more combinations of these. Note that the formation of the first to fourth regions R1 to R4 may be accomplished by utilizing the above-mentioned coating material, by attaching a sticker, tape or the like, by providing plural projecting portions, or by doing the like. FIG. 30 shows an example in which tape having different friction coefficients is attached in line form around the mounting member 600. In this case, what may be done to avoid a misalignment between the container 20 and the mounting member 600 is for example: to provide each of the bottom portion of the container and the inside of the mounting member with an engagement portion; to form the mounting member 600 with a material having high friction, such as rubber; or to do the like. In this way, the misalignment after attachment may be prevented.

In any one of the above-mentioned exemplary embodiments, an example has been given in which two identification marks 23 of the container 20 lie on the circumference with such a positional relationship that their phases are shifted 180 degrees. However, as shown in FIG. 31A, even if the two identification marks 23 are present without such a positional relationship that their phases are shifted 180 degrees, relationships between the positions of the identification marks 23 and the position of the guide may be calculated thereby to set the widths of the first to fourth regions R1 to R4 in a nonuniform fashion. Alternatively, as shown in FIG. 31B, if three identification marks 23 are present, regions R1, R3 and R5 are given a high friction coefficient, and regions R2, R4 and R6 are given a low friction coefficient, whereby the widths of the regions are likewise determined, based on the positional relationships of identification marks 23a, 23b and 23c and the guide.

### Seventh Exemplary Embodiment

FIG. 33 (FIGS. 33A and 33B) is a view showing a schematic configuration of the display device according to the seventh exemplary embodiment.

As shown in FIG. 33A, the display device 30 according to this exemplary embodiment includes: the placement unit 31 on which the containers 20 (an example of an article) are to be placed; and the guides 32 that form a movement route (a movement path) of the containers 20, and that guide movement of the containers 20, as in the case of the above. The containers 20 each have a film F, with a pattern printed thereon, mounted on the outer circumferential face thereof, and filled with drink therein. The display device 30 also includes the regulation plate 34 that is preferably formed transparently, arranged along one side of the placement unit 31 and that stops movement of the containers 20. The display device 30 also includes a rotation mechanism 5000 that rotates the container 20, so that the identification mark 23 attached on the container 20 is caused to face frontward.

The display device 30 is, as shown in FIG. 33B, put inside the display case 10 installed in a convenience store, a super market or the like, as in the case of the above. This display case 10 includes: the case main body unit 10A formed into a rectangular parallelepiped shape; and the doors 10B provided so as to be openable and closable with respect to this case main body unit 10A, which form the main part of the display case 10, as in the case of the above.

Here, the display device 30 is placed on a shelf (not shown in the figure) provided to the display case 10. On this occasion, the display device 30 is placed so that the side thereof where the regulation plate 34 is provided is located at the side where the doors 10B are provided. Additionally, the placement unit 31 of the display device 30 is arranged so that the side thereof where the regulation plate 34 is provided is positioned at a lower level than a side thereof opposite to the side where the regulation plate 34 is provided. That is, the placement unit 31 of the display device 30 is arranged in the downward sloping state from the back side of the display case 10 toward the front side thereof (the side of the taken-out portion) from which the containers 20 are taken out.

Here, the display case 10 in this exemplary embodiment also has a door (not shown in the figure) provided on the back side thereof, as in the case of the above, whereby the back side becomes also openable. The containers 20 are supplied to the display device 30 from this back side. That is, the display case 10 has a configuration where the supplying portion for the containers 20 is provided at the back side of the display case 10, and at the back side of the display device 30. The containers 20 having been supplied move on the placement unit 31 toward the side of the doors 10B. That is, the containers 20 having been supplied move toward purchasers who purchase the containers 20. Note that, in this description of the invention, the side where the doors 10B are provided is sometimes referred to as a front side (frontward), whereas the side opposite to the doors 10B is sometimes referred to as a back side (backward). The width direction (a direction orthogonal to a direction in which the containers 20 move) of the display case 10 is sometimes referred to as a lateral direction, or as a width direction.

Description will now be given with regard to the display device 30 in more detail.

FIG. 34 (FIGS. 34A and 34B) is a top view and a side view of the display device 30. Specifically, FIG. 34A shows a top view, and FIG. 34B shows a right side view. Also, FIG. 35 is a cross-sectional view taken along the line) XXXV-XXXV of FIG. 34B.

In the display device 30 according to this exemplary embodiment, as shown in FIG. 34A, the placement unit 31 is provided with plural roll-shaped members 3110. As described specifically, the placement unit 31 is provided with a first roller array 3120 formed of the plural roll-shaped members 3110 arrayed in the front-back direction, and a second roller array 3130 formed of the plural roll-shaped members 3110 arrayed in the front-back direction in the same manner. Each of the roll-shaped members 3110 is provided so as to be rotatable along the movement route of the containers 20, and smoothly moves the containers 20 frontward.

Also, the display device 30 includes the rotation mechanism 5000 that rotates the container 20 to make the identification mark 23 attached on the container 20 face frontward, as mentioned above.

Here, as shown in FIG. 34A, the rotation mechanism 5000 includes: a rod-shaped member 51A that is provided along the movement route of the containers 20 and above the placement unit 31; and first to sixth pins 521A to 526A, as an example of protruding portions, that are attached to the rod-shaped member 51A, and that protrude into the movement route of the containers 20. Here, in this exemplary embodiment, the first pin 521A is arranged on the most upstream side in the movement direction of the containers 20, while the sixth pin 526A is arranged on the most downstream side in the movement direction. Also, the first to sixth pins 521A to 526A are arranged at regular intervals. Also, the rotation mechanism 5000 includes fixing members 53 that fix the rod-shaped member 51A to the guide 32 of the right-hand side. Note that the first to sixth pins 521A to 526A may be considered as a rotation unit that rotates the container 20.

Also, as shown in FIG. 34B, the rod-shaped member 51A is sloped so as to be away from the placement unit 31 toward the front. Thus, in this exemplary embodiment, the first pin 521A is arranged closest to the placement unit 31, whereas the sixth pin 526A is located at a farthest position away from the placement unit 31. As mentioned in addition, the first to sixth pins 521A to 526A are arranged in different positions with respect to one another in a height direction. Note that in FIG. 34B, the slope of the rod-shaped member 51A is shown as being greater than its actual slope in order to facilitate understanding.

Also, the fixing members 53 in this exemplary embodiment are inserted in the guide 32 of the right-hand side and are slidable with respect to the guide 32 of the right-hand side. Thus, in the display device 30 according to this exemplary embodiment, the fixing members 53 may be slid with respect to the guide 32 of the right-hand side thereby to move the first to sixth pins 521A to 526A in the height direction. Also, in this exemplary embodiment, there are provided screws 54 that position the respective fixing members 53 in the guide 32 of the right-hand side.

As described in further detail with reference to FIG. 35, the guide 32 of the right-hand side includes holes 32A each in a rectangular form. Then, in this exemplary embodiment, the fixing members 53 are slidably inserted in the holes 32A, respectively. Then, the fixing members 53 inserted in the holes 32A may be slid thereby to move the first to sixth pins 521A to 526A in the height direction. Also, the fixing members 53 are fixed by being pressed against inner walls of the holes 32A by the screws 54, respectively.

The first to sixth pins 521A to 526A may be arranged in the following manner.

FIG. 36 (FIGS. 36A and 36B) is a view showing a modified example of the display device 30. FIG. 36A is a top view of the display device 30, and FIG. 36B is a cross-sectional view taken along the line XXXVIB-XXXVIB of FIG. 36A.

The display device 30 is provided with a supporting member 200 that is arranged across the guide 32 of the right-hand side and the guide 32 of the left-hand side, and used to support the first to sixth pins 521A to 526A. The supporting member 200 is formed into an arch shape (a gate shape), and includes: a first leg portion 201 that is fixed to the guide 32 of the left-hand side and that extends upward from the guide 32 of the left-hand side; a second leg portion 202 that is fixed to the guide 32 of the right-hand side and that extends upward from the guide 32 of the right-hand side; and a ceiling portion 203 that connects the first leg portion 201 and the second leg portion 202.

Also, the display device 30 is provided with a supported member 250 that extends downward from the ceiling portion 203, ant that is provided along the movement route of the containers 20 and supported by the ceiling portion 203. Then, in the display device 30, the first to sixth pins 521A to 526A are attached to the supported member 250. As later described, in this exemplary embodiment, the first to sixth pins 521A to 526A are pressed by the container 20. On this occasion, the first to sixth pins 521A to 526A might undergo displacement; however, this configuration reduces the likelihood of displacement of the first to sixth pins 521A to 526A. Vertical movement of the first to sixth pins 521A to 526A may be conducted for example by sliding the supporting member 200 along the guides 32.

Also, description has been given above with regard to a configuration in which the fixing members 53 are slid thereby to move the first to sixth pins 521A to 526A in the height direction; however, the following configuration may be adopted to move the first to sixth pins 521A to 526A in the height direction.

FIG. 37 (FIGS. 37A and 37B) is a view showing a modified example of the display device 30. FIG. 37A is a top view of the display device 30, and FIG. 37B is a cross-sectional view taken along the line XXXVIIB-XXXVIIB of FIG. 37A.

The display device 30 is provided with the supporting member 200, as in the case of the above. Further, the display device 30 is provided with a fixing member 260 that is fixed to the second leg portion 202 of the supporting member 200.

The fixing member 260 is provided along the movement route of the containers 20. Also, the fixing member 260 includes plural grooves 261 that are provided along the movement route of the containers 20 and in which the above-mentioned rod-shaped member 51A fits. As further described, the plural grooves 261 (three in this modified example) are provided, and are arranged side by side in an upward direction. In the display device 30, the grooves 261 in which the rod-shaped member 51A fits are made different so that the positions of the first to sixth pins 521A to 526A are different in the height direction.

Also, the display device 30 may be configured in the following manner.

FIG. 38 is a view showing a modified example of the display device 30.

In FIGS. 37A and 37B, one supporting member 200 is provided for one movement route (the movement route of the containers, or a moving lane); however, one supporting member 200 may be provided for plural movement routes (three in this modified example). As mentioned in addition, the ceiling portion 203 may be longer than the ceiling portion 203 shown in FIG. 37B thereby to provide one supporting member 200 for the plural movement routes.

The display device 30 is provided with the fixing members 260 corresponding to the movement routes, respectively. Here, the fixing members 260 are fixed to the ceiling portion 203. In this modified example, description has been given by taking a case where the fixing members 260 are provided as an example; however, the supported members 250 described in FIGS. 36A and 36B may be provided for the movement routes, respectively.

Description will now be given with regard to the container 20.

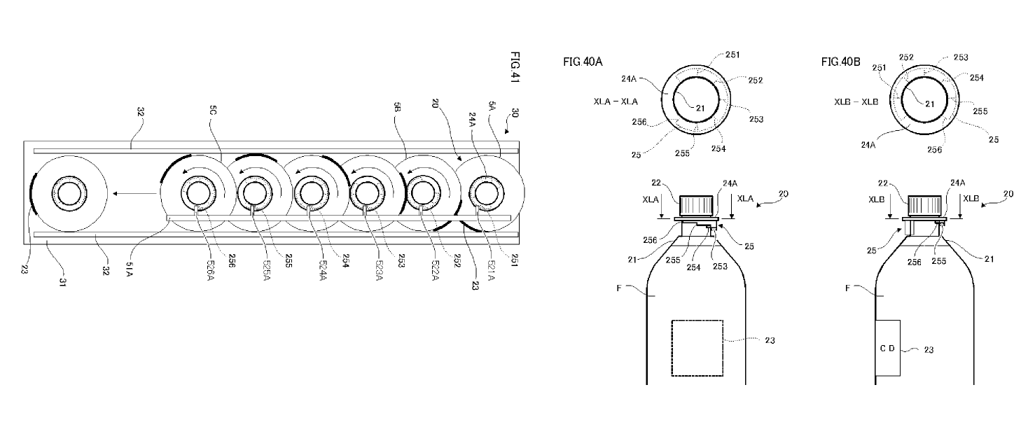

FIG. 39 (FIGS. 39A and 39B) and FIG. 40 (FIGS. 40A and 40B) are views for explaining the container 20. FIG. 39A shows a front elevational view of the container 20, and FIG. 39B shows a left side view of the container 20. Also, FIG. 40A shows a rear elevational view of the container 20, and FIG. 40B shows a right side view of the container 20. Also, views shown in upper parts of FIGS. 39A and 39B and FIGS. 40A and 40B show cross-sectional views taken along the line XXXIXA-XXXIXA, the line XXXIXB-XXXIXB, the line XLA-XLA, and the line XLB-XLB, respectively.

The container 20 according to this exemplary embodiment is illustrated as a container made of a resin material such as PET (polyethylene terephthalate). For example, an injection molding (blow molding) method using a resin material, or a method that involves molding a preform by use of a resin material and then blow-molding the preform may be used to manufacture such a container 20.

As shown in FIG. 39A, the container 20 according to this exemplary embodiment includes: the container body 21 (an example of an article body portion) that has the opening (the lip) in the upper portion thereof, and that is formed into a tubular form and filled with drink therein; and the cap 22 that closes the opening of the container body 21, as in the case of the above. Also, the film F is mounted on the outer circumferential face of the container body 21. The diameter of the container body 21 on the upper portion side is smaller than the diameter thereof on the bottom portion side. In other words, the container body 21 is such that the upper portion side has the reduced diameter.

Here, the identification mark 23 for differentiating the container 20 from other products, such as a trade name or a trademark, is printed on the film F, as shown in FIG. 39A.

Also, the container 20 includes a first projecting portion 24A that is provided above the container body 21 (below the cap 22) and that annularly projects from the outer circumferential face of the container body 21 in the radial direction of the container body 21. Here, the first projecting portion 24A is integrally formed with the container body 21.

Further, the container 20 includes a second projecting portion 25 under the first projecting portion 24A. Here, the amount of projection of the second projecting portion 25 is smaller than the amount of projection of the first projecting portion 24A. This instance reduces the likelihood that, when a user operates the cap 22, his or her fingers will be caught on the second projecting portion 25, as compared to an instance where the second projecting portion 25 projects beyond the first projecting portion 24A. Also, as shown in the cross-sectional view of FIG. 39A, the second projecting portion 25 is provided so as to wrap around the container body 21, from the side thereof on which the identification mark 23 is provided, to the opposite side thereof to the side on which the identification mark 23 is provided. As mentioned in addition, the second projecting portion 25 is provided in a clockwise direction, from the side on which the identification mark 23 is provided, toward the opposite side. As further described, the second projecting portion 25 is provided within a predetermined range in the circumferential direction of the container body 21.

As further described, the container 20 is configured so that the second projecting portion 25 is not provided on a right side face of the container 20 as viewed from the side thereof on which the identification mark 23 is provided (see FIG. 39A). As mentioned in addition, at the provided position of the second projecting portion 25 in the height direction, the right side face of the container 20 (a region adjacent to the second projecting portion 25) is such that the container body 21 is exposed. As further described, a configuration is such that the second projecting portion 25 is not provided to the container 20 at a position rightward of a tangent line (see the cross-sectional view of FIG. 39A) that is tangent to a right side face of the container body 21, that extends from a front face side of the container 20 toward a rear face side thereof, and that passes through the provided position of the above-mentioned second projecting portion 25 in the height direction.

Also, the second projecting portion 25 is formed at its bottom face in a stepped form, and is configured by including plural step portions. As described specifically, the second projecting portion 25 is formed at its bottom face in a stepped form so that its height decreases in the clockwise direction. Thus, the second projecting portion 25 in this exemplary embodiment is configured by including, in its bottom portion, first to sixth flat faces 251 to 256 (an example of contact portions), the positions of which are different from one another in the height direction. As mentioned in addition, the second projecting portion 25 includes plural end faces, the positions of which are different from one another in the height direction and are also different from one another in the circumferential direction of the container body 21. Here, a region where the second projecting portion 25 (the first to sixth flat faces 251 to 256) is provided may be considered as a face forming portion.

Here, each of the first to sixth flat faces 251 to 256 is arranged so as to intersect with (be substantially orthogonal to) the outer circumferential face of the container body 21, as shown in FIG. 39A. Also, the first flat face 251 is located on the side on which the identification mark 23 is provided, as shown in FIG. 39A. Also, the sixth flat face 256 is located on the opposite side to the side on which the identification mark 23 is provided, as shown in FIG. 40A. Also, the second to fifth flat faces 252 to 255 are provided so that the second flat face 252, the third flat face 253, the fourth flat face 254 and the fifth flat face 255 are arranged in this order in a direction from the first flat face 251 to the sixth flat face 256. Further, the first to sixth flat faces 251 toward 256 are provided at intervals of a predetermined angle in the circumferential direction of the container 20. Also, the first flat face 251 is located in the lowermost portion, and the sixth flat face 256 is located in the uppermost portion.

The above-mentioned second projecting portion 25 or later-described first to fifth protrusions 241 to 245 may be formed at the time of formation of the container 20. Alternatively, attachment or the like of other members such as resin pieces or metal pieces may be separately performed to form the second projecting portion 25 or the first to fifth protrusions 241 to 245.

Description will now be given with regard to behavior of the container 20 in the display device 30.

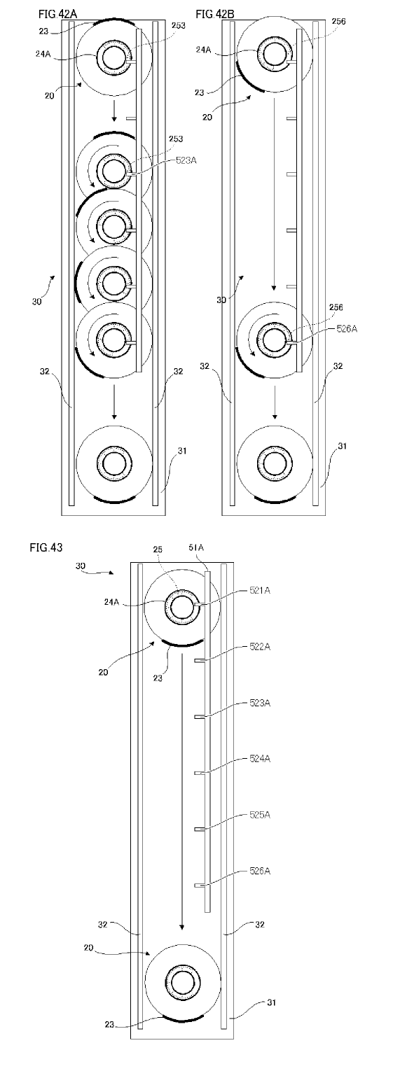

FIG. 41 is a view for explaining the behavior of the container 20 in the display device 30. Illustration of the first roller array 3120, the second roller array 3130 and the fixing members 53 is omitted from FIG. 41. Also, in FIG. 41 and so on, the first to sixth pins 521A to 526A are shown above the first projecting portion 24A in order that the drawing may be readily seen. As indicated by the reference numeral 5A in FIG. 41, when the container 20 is supplied to the display device 30 with the identification mark 23 facing diagonally forward right, the first flat face 251 engages against the first pin 521A. Thereby, rotational force is applied to the container 20, so that the container 20 makes counterclockwise rotation. Then, as the container 20 moves frontward, the second flat face 252 engages against the second pin 522A (see the reference numeral 5B), and thus, the container 20 likewise makes counterclockwise rotation.

After that, the container 20 makes circumferential rotation in sequence by the third flat face 253 engaging against the third pin 523A, the fourth flat face 254 engaging against the fourth pin 524A, and the fifth flat face 255 engaging against the fifth pin 525A. Finally, the sixth flat face 256 engages against the sixth pin 526A (see the reference numeral 5C), so that the identification mark 23 comes to face frontward. After that, the container 20 slides on the placement unit 31 and reaches the front of the display device 30.

In this exemplary embodiment, the identification mark 23 and the region where the second projecting portion 25 (the first to sixth flat faces 251 to 256) is provided are arranged with a predetermined positional relationship. Also, the identification mark 23 and the region where the second projecting portion 25 is not provided are likewise arranged with a predetermined positional relationship. Specifically, when the identification mark 23 faces one direction, the region where the second projecting portion 25 is not provided faces a direction orthogonal to the one direction.

Thus, in this exemplary embodiment, the container 20 rotates when the identification mark 23 faces a direction other than frontward, whereas the container 20 does not rotate when the identification mark 23 faces frontward. As mentioned in addition, even if the container 20 is supplied without the identification mark 23 facing frontward, the identification mark 23 ends up facing frontward when the container 20 reaches the front side of the display device 30. In other words, in this exemplary embodiment, even if the supplier who supplies the containers 20 to the display device 30 does not perform any particular operations, the identification mark 23 will come to face frontward.

Note that the positions of the first to sixth pins 521A to 526A in the height direction are adjusted in advance, although description has been omitted above. Specifically, the positions of the first to third pins 521A to 523A in the height direction are adjusted in advance so that the first pin 521A engages against the first flat face 251, so that the second pin 522A engages against the second flat face 252, and so that the third pin 523A engages against the third flat face 253. Also, the positions of the fourth to sixth pins 524A to 526A in the height direction are adjusted in advance so that the fourth pin 524A engages against the fourth flat face 254, so that the fifth pin 525A engages against the fifth flat face 255, and so that the sixth pin 526A engages against the sixth flat face 256.

Description will now be given with regard to another example of behavior of the container 20.

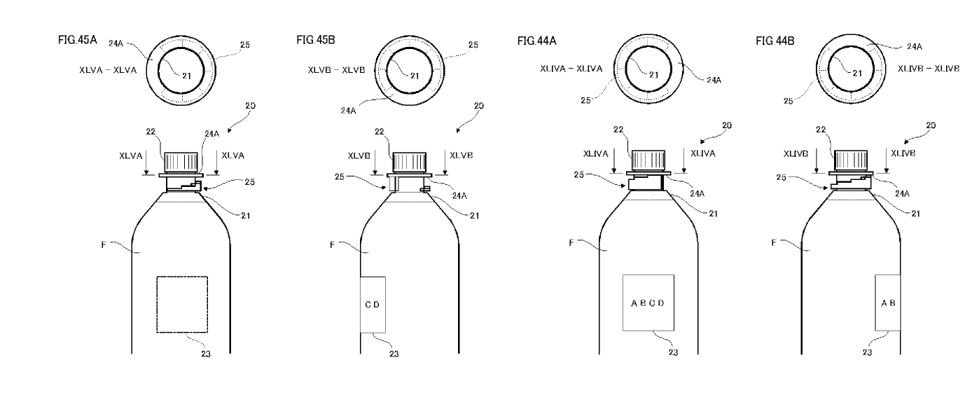

FIG. 42 (FIGS. 42A and 42B) and FIG. 43 are views showing another example of behavior of the container 20.

As shown in FIG. 42A, when the container 20 is supplied with the identification mark 23 facing toward the back side of the display device 30, the third flat face 253 faces toward the front of the display device 30. Then, the container 20 moves frontward, while the third flat face 253 passes above the first pin 521A and the second pin 522A (see also FIG. 34B). Thus, the container 20 reaches the third pin 523A without rotating. Then, the container 20 receives rotational force from the third pin 523A and thus makes rotation in the same manner as described above. Then, the container 20 reaches the front of the display device 30 with the identification mark 23 facing frontward, in the same manner as described above.

Also, as shown for example in FIG. 42B, when the container 20 is supplied with the identification mark 23 facing diagonally forward left, the sixth flat face 256 faces toward the front of the display device 30. Then, the container 20 moves frontward, while the sixth flat face 256 passes above the first to fifth pins 521A to 525A (see also FIG. 34B). Thus, the container 20 reaches the sixth pin 526A without rotating. Then, the container 20 receives rotational force from the sixth pin 526A and thus makes rotation in the same manner as described above. Then, the container 20 reaches the front of the display device 30 with the identification mark 23 facing frontward, in the same manner as described above.

Further, as shown for example in FIG. 43, the container 20 may be supplied with the identification mark 23 facing frontward. In this case, the second projecting portion 25 is not present on a side face of the container 20 facing the side on which the first to sixth pins 521A to 526A are arranged. As mentioned in addition, the region (the face) where the second projecting portion 25 is not present is opposed to the side on which the first to sixth pins 521A to 526A are arranged. As further mentioned, the first to sixth flat faces 251 to 256 that engage against the first to sixth pins 521A to 526A are not located on the right side face of the container 20 in the drawing. Thus, the container 20 reaches the front of the display device 30 without making rotation. In other words, the container 20 reaches the front of the display device 30 while keeping its state with the identification mark 23 facing frontward.

The behavior of the container 20 in a case of one container 20 being supplied has been described above. If plural containers 20 are already displayed in the display device 30, taking out the container 20 located at the front forms space equivalent to this container 20. Then, the second container 20 moves toward this space. Then, movement of the container 20 following after the second container 20 also starts. On this occasion, each of the containers 20 is rotated by the first to sixth pins 521A to 526A, and thus, the identification mark 23 of each container 20 comes to face frontward.

The container 20 may have the following configuration.

FIG. 44 (FIGS. 44A and 44B) and FIG. 45 (FIGS. 45A and 45B) are views showing a modified example of the container 20. FIG. 44A shows a front elevational view of the container 20, and FIG. 44B shows a left side view of the container 20. Also, FIG. 45A shows a rear elevational view of the container 20, and FIG. 45B shows a right side view of the container 20. Also, views shown in upper parts of FIGS. 44A and 44B and FIGS. 45A and 45B show cross-sectional views taken along the line XLIVA-XLIVA, the line XLIVB-XLIVB, the line XLVA-XLVA, and the line XLVB-XLVB, respectively.

In the container 20 shown in FIGS. 39A and 39B as well as FIGS. 40A and 40B, the stepped portions of the second projecting portion 25 are provided on the bottom face (the bottom portion) of the second projecting portion 25; however, in this modified example, the stepped portions are provided on a top face (a top portion) of the second projecting portion 25. When the container 20 having such a configuration is used, the display device 30 shown in FIG. 46 (FIGS. 46A and 46B) (a view showing a modified example of the display device 30) is used.

In this display device 30, the slope of the rod-shaped member 51A is made different from the slope of the rod-shaped member 51A shown in FIGS. 34A and 34B. Specifically, the rod-shaped member 51A in this modified example is arranged so as to be closer to the placement unit 31 toward the front. Thus, in the display device 30, the sixth pin 526A is arranged closest to the placement unit 31, whereas the first pin 521A is located at a farthest position away from the placement unit 31.

A modified example of the container 20 will be further described.

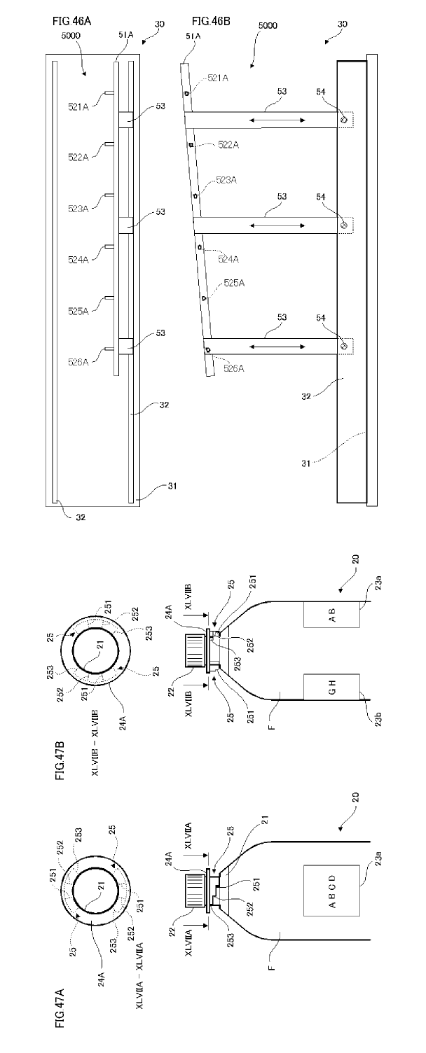

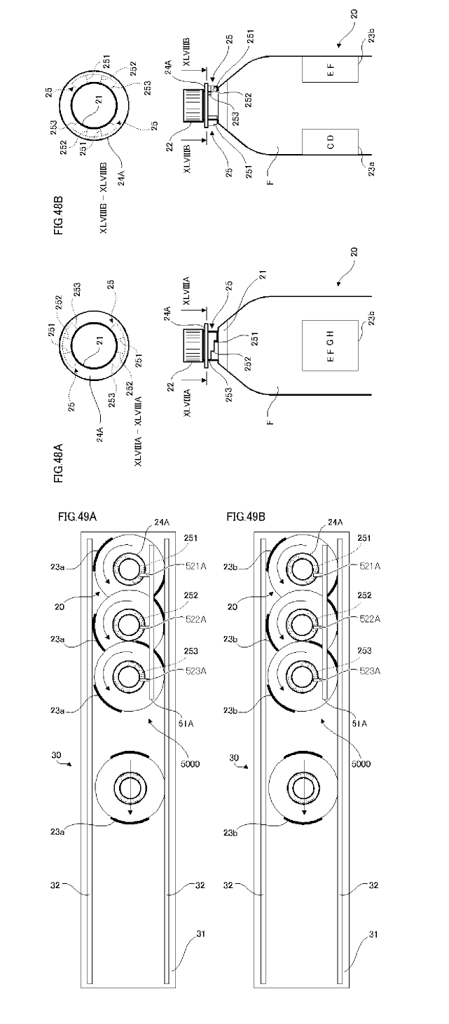

FIG. 47 (FIGS. 47A and 47B) and FIG. 48 (FIGS. 48A and 48B) are views of another modified example of the container 20. FIG. 47A shows a front elevational view of the container 20, and FIG. 47B shows a left side view of the container 20. Also, FIG. 48A shows a rear elevational view of the container 20, and FIG. 48B shows a right side view of the container 20. Also, views shown in upper parts of FIGS. 47A and 47B and FIGS. 48A and 48B show cross-sectional views taken along the line XLVIIA-XLVIIA, the line XLVIIB-XLVIIB, the line XLVIIIA-XLVIIIA, and the line XLVIIIB-XLVIIIB, respectively.

The container 20 in this modified example is provided with two identification marks 23. Specifically, the container 20 is provided with the first identification mark 23a and the second identification mark 23b. Here, the first identification mark 23a and the second identification mark 23b are arranged with their phases shifted 180 degrees in the circumferential direction of the container 20. As mentioned in addition, the second identification mark 23b is provided on the opposite side to the side on which the first identification mark 23a is provided.

Also, the container 20 according to this modified example is provided with two second projecting portions 25. Specifically, one of the second projecting portions 25 is provided above the first identification mark 23a, while the other second projecting portion 25 is provided above the second identification mark 23b. As further described, a configuration is such that the second projecting portions 25 are not provided at positions where their phases are shifted 90 degrees with respect to the first identification mark 23a and the second identification mark 23b. Each of the second projecting portions 25 is formed at its bottom face in a stepped form and includes the first to third flat faces 251 to 253 in its bottom portion, as in the case of the above.

Description will now be given with regard to behavior of the container 20 in the display device 30.

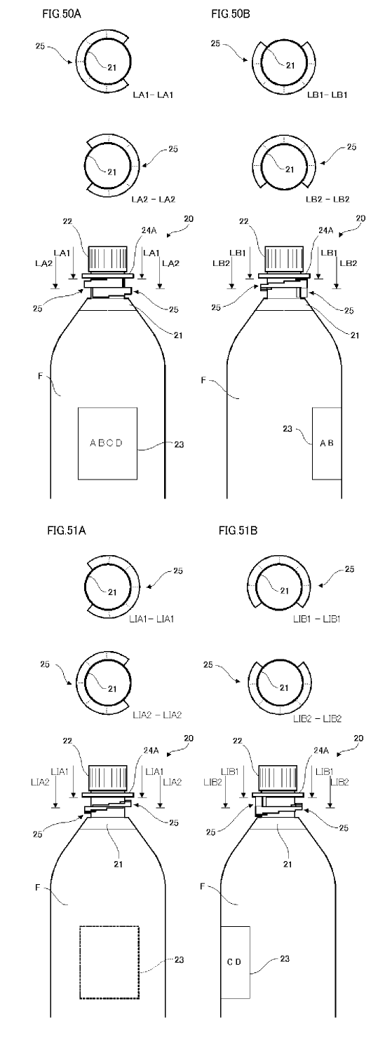

FIG. 49 (FIGS. 49A and 49B) is a view for explaining the behavior of the container 20 in the display device 30.

As shown in FIG. 49A, when the container 20 is supplied for example with the first identification mark 23a facing toward the back side of the display device 30, the first flat face 251 of one of the two second projecting portions 25 faces toward the front of the display device 30. Then, the container 20 moves frontward. On this occasion, the first flat face 251 engages against the first pin 521A. As a result, the container 20 rotates counterclockwise. After that, the second flat face 252 engages against the second pin 522A, and thus, the container 20 further rotates. Also, the third flat face 253 engages against the third pin 523A, and thus, the container 20 further rotates. Thereby, the first identification mark 23a comes to face frontward.

Also, as shown in FIG. 49B, when the container 20 is supplied for example with the second identification mark 23b facing toward the back side of the display device 30, the first flat face 251 of the other of the two second projecting portions 25 faces toward the front of the display device 30. Then, the container 20 moves frontward. On this occasion, the first flat face 251 engages against the first pin 521A. As a result, the container 20 rotates counterclockwise. After that, the second flat face 252 engages against the second pin 522A, and thus, the container 20 further rotates. Also, the third flat face 253 engages against the third pin 523A, and thus, the container 20 further rotates. Thereby, the second identification mark 23b comes to face frontward.

In the above-mentioned container 20, each of the second projecting portions 25 is provided with three flat faces. In the display device 30, therefore, three pins are provided corresponding to the three flat faces, respectively. That is, this modified example may reduce the number of pins, because rotation of close to 360 degrees of the container 20 is not necessary (see FIG. 41). As a result, a configuration is such that the rotation mechanism 5000 is provided only in an upper portion of the display device 30, as shown in FIGS. 49A and 49B.

In the display device 30 shown in FIG. 34, the first to sixth pins 521A to 526A are provided on the right-hand side of the movement route of the containers 20; however, it may be desired that the first to sixth pins 521A to 526A be provided on the left-hand side of the movement route, from the viewpoint of installation space or the like. Incidentally, supply of the above-mentioned container 20 to the display device 30 having such a configuration may not lead to rotation of the container 20. Therefore, the container 20 may have the following configuration.

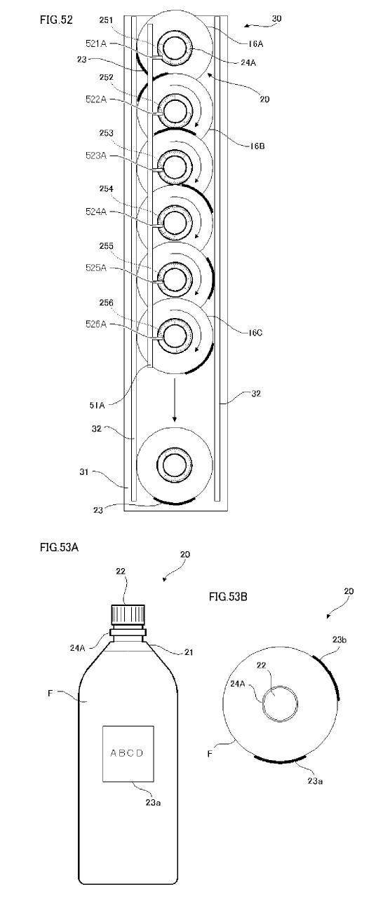

FIG. 50 (FIGS. 50A and 50B) and FIG. 51 (FIGS. 51A and 51B) are views showing another modified example of the container 20. FIG. 50A shows a front elevational view of the container 20, and FIG. 50B shows a left side view of the container 20. Also, FIG. 51A shows a rear elevational view of the container 20, and FIG. 51B shows a right side view of the container 20. Also, views shown in upper parts of FIGS. 50A and 50B and FIGS. 51A and 51B show cross sections taken along the line LA1-LA1, the line LA2-LA2, the line LB1-LB1, the line LB2-LB2, the line LIA1-LIA1, the line LIA2-LIA2, the line LIB1-LIB1, and the line LIB2-LIB2.

Here, the container 20 according to this modified example is provided with two second projecting portions 25, as in the case of the above. However, the two projecting portions 25 are arranged as shifted vertically with respect to each other. As mentioned in addition, one of the second projecting portions 25 is provided above, while the other second projecting portion 25 is provided below.

Here, the one second projecting portion 25 arranged above has the same configuration as the second projecting portion 25 shown in FIGS. 39A and 39B as well as FIGS. 40A and 40B, except for its dimension in the height direction.

Also, the other second projecting portion 25 arranged below has basically the same configuration as the second projecting portion 25 shown in FIGS. 39A and 39B as well as FIGS. 40A and 40B. In other words, the other second projecting portions 25 are provided so as to wrap around the container body 21, from the side thereof on which the identification mark 23 is provided, toward the opposite side thereof to the side on which the identification mark 23 is provided.

However, the other second projecting portion 25 arranged below is provided, from the side thereof on which the identification mark 23 is provided, in a counterclockwise direction, as distinct from the second projecting portion 25 positioned above. As further described, a configuration is such that, at the position of the lower second projecting portion 25 in the height direction, the second projecting portion 25 is not provided on a left side face of the container 20 (see FIG. 50A). As mentioned in addition, the container body 21 is exposed on this left side face thereof.

Description will now be given with regard to behavior of the container 20 in the display device 30.

FIG. 52 is a view for explaining the behavior of the container 20 in the display device 30. Here, FIG. 52 shows the display device 30 in which the first to sixth pins 521A to 526A are provided on the left-hand side of the movement route of the containers 20.

As indicated by the reference numeral 16A in FIG. 52, when the container 20 is supplied to the display device 30 with the identification mark 23 facing diagonally forward left, the first flat face 251 of the second projecting portion 25 positioned below engages against the first pin 521A. Thereby, rotational force is applied to the container 20, so that the container 20 makes clockwise rotation. Then, as the container 20 moves frontward, the second flat face 252 engages against the second pin 522A (see the reference numeral 16B), and thus, the container 20 likewise makes clockwise rotation.

After that, the container 20 makes clockwise rotation in sequence by the third flat face 253 engaging against the third pin 523A, the fourth flat face 254 engaging against the fourth pin 524A, and the fifth flat face 255 engaging against the fifth pin 525A. Finally, the sixth flat face 256 engages against the sixth pin 526A (see the reference numeral 16C), so that the identification mark 23 faces frontward. After that, the container 20 slides on the placement unit 31 and reaches the front of the display device 30 with the identification mark 23 facing frontward.

Note that if the first to sixth pins 521A to 526A are provided at positions corresponding to the upper second projecting portion 25, the above-mentioned rotation of the container 20 is unfeasible. Thus, when the first to sixth pins 521A to 526A are provided on the left-hand side of the movement route of the containers 20, it is required that the positions of the first to sixth pins 521A to 526A (the fixing members 53) be adjusted so that the first to sixth pins 521A to 526A correspond to the lower second projecting portion 25.

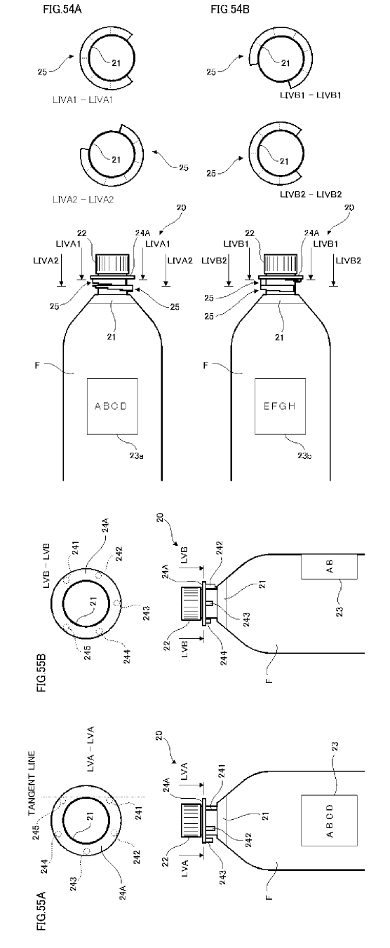

Incidentally, the container 20 is not limited to being provided with one identification mark 23 but is often provided with two identification marks 23. Also, the two provided identification marks 23 are not limited to being arranged with their phases shifted 180 degrees but may be arranged with their phases shifted degrees other than 180 degrees, as shown in FIG. 53 (FIGS. 53A and 53B) (a view for explaining the arrangement positions of the identification marks 23 on the container 20). Such a container 20 may be provided with the second projecting portions 25 in the following manner.

FIG. 54 (FIGS. 54A and 54B) is a view showing another modified example of the container 20.

Here, the container 20 in FIGS. 54A and 54B is provided with two identification marks 23, namely, the first identification mark 23a and the second identification mark 23b. FIG. 54A shows a view of the container 20 as seen from the side thereof on which the first identification mark 23a is provided, and FIG. 54B shows a view of the container 20 as seen from the side thereof on which the second identification mark 23b is provided. Also, views shown in upper parts of FIGS. 54A and 54B show cross sections taken along the line LIVA1-LIVA1, the line LIVA2-LIVA2, the line LIVB1-LIVB1, and the line LIVB2-LIVB2. Here, FIGS. 54A and 54B illustrate a case where the first identification mark 23a and the second identification mark 23b are arranged with their phases shifted 120 degrees.

The container 20 according to this modified example is also provided with two second projecting portions 25. One of the second projecting portions 25 is arranged above, while the other second projecting portion 25 is arranged below. Also, the one second projecting portion 25 and the other second projecting portion 25 are provided as shifted with respect to each other in the circumferential direction of the container 20. Each of the two second projecting portions 25 has the same configuration as the second projecting portion 25 shown in FIGS. 39A and 39B as well as FIGS. 40A and 40B, except for its dimension in the height direction.

Also, the second projecting portion 25 positioned above is provided corresponding to the first identification mark 23a, while the second projecting portion 25 positioned below is provided corresponding to the second identification mark 23b.

Thus, at the position where the upper second projecting portion 25 is provided (the position thereof in the height direction), the second projecting portion 25 is not provided on a right side face of the container body 21, so that the container body 21 is exposed (see FIG. 54A). Also, at the position where the lower second projecting portion 25 is provided (the position thereof in the height direction), the second projecting portion 25 is not provided on a right side face of the container body 21, so that the container body 21 is exposed (see FIG. 54B).

Here, in order for the display device 30 to make the first identification mark 23a face frontward, the positions of the fixing members 53 in the height direction are adjusted thereby to arrange the above-mentioned first to sixth pins 521A to 526A so as to correspond to the second projecting portion 25 positioned above. Then, when the container 20 is supplied to the display device 30 in this state, the first identification mark 23a comes to face frontward, as described above. Also, in order for the display device 30 to make the second identification mark 23b face frontward, the positions of the fixing members 53 in the height direction are adjusted thereby to arrange the first to sixth pins 521A to 526A so as to correspond to the second projecting portion 25 positioned below. Then, when the container 20 is supplied in this state, the second identification mark 23b comes to face frontward.

Alternatively, the container 20 may have the following configuration.

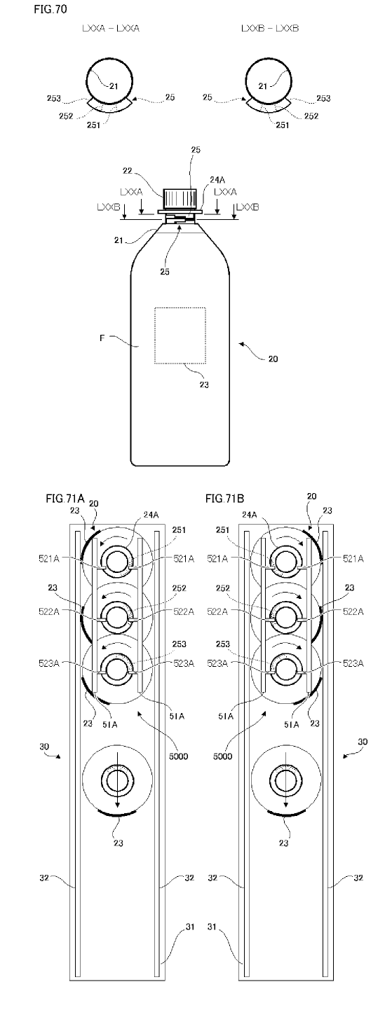

FIGS. 69 and 70 are views showing another modified example of the container 20. FIG. 69 is a front elevational view of the container 20, and FIG. 70 is a rear elevational view of the container 20. Also, two views shown in an upper part of FIG. 70 show cross-sectional views taken along the line LXXA-LXXA and the line LXXB-LXXB, respectively.

Here, the container 20 is provided with one identification mark 23 as shown in FIG. 69, and is provided with the first projecting portion 24A as in the case of the above. Further, the container 20 is provided with two second projecting portions 25 on the opposite side thereof to the side on which the identification mark 23 is provided, as shown in FIG. 70. As further described, the two second projecting portions 25 are provided at positions such that their phases are shifted 180 degrees with respect to the identification mark 23. Also, the second projecting portions 25 are configured so as not be provided at positions such that their phases are shifted 90 degrees and −90 degrees with respect to the identification mark 23.

The two second projecting portions 25 are arranged as vertically shifted with respect to each other. As mentioned in addition, one of the second projecting portions 25 is provided above, while the other second projecting portion 25 is provided below.

Here, the one second projecting portion 25 arranged above has the same configuration as the second projecting portion 25 shown in FIG. 47A, except for its dimension in the height direction. Specifically, the one second projecting portion 25 arranged above is formed at its bottom face in a stepped form and includes the first to third flat faces 251 to 253 in its bottom portion. As further described also with reference to the cross-sectional view taken along the line LXXA-LXXA, the first to third flat faces 251 to 253 are provided so that the first flat face 251, the second flat face 252 and the third flat face 253 are arranged in this order in the clockwise direction.

Also, the other second projecting portion 25 arranged below has basically the same configuration as the above-mentioned one second projecting portion 25 arranged above. However, as shown in the cross-sectional view taken along the line LXXB-LXXB, the first to third flat faces 251 to 253 are provided so that the third flat face 253, the second flat face 252 and the first flat face 251 are provided in this order in the clockwise direction.

Description will now be given with regard to behavior of the container 20 in the display device 30.

FIG. 71 (FIGS. 71A and 71B) is a view for explaining the behavior of the container 20 in the display device 30. Here, FIGS. 71A and 71B shows the display device 30 in which the first to third pins 521A to 523A are provided on the left-hand side of the movement route of the container 20, and the first to third pins 521A to 523A are also provided on the right-hand side of the movement route of the container 20.

As shown in FIG. 71A, when the container 20 is supplied for example with the identification mark 23 facing toward the left side and the back side of the display device 30, the first flat face 251 of one of the above-mentioned two second projecting portions 25 (the upper second projecting portion 25) faces toward the front of the display device 30. Then, the container 20 moves frontward. On this occasion, the first flat face 251 engages against the first pin 521A provided on the right-hand side of the movement route. As a result, the container 20 rotates counterclockwise. After that, the second flat face 252 engages against the second pin 522A provided on the same right-hand side, and thus, the container 20 further rotates. Also, the third flat face 253 engages against the third pin 523A provided on the same right-hand side, and thus, the container 20 further rotates. Thereby, the identification mark 23 comes to face frontward.

Also, as shown in FIG. 71B, when the container 20 is supplied for example with the identification mark 23 facing toward the right side and the back side of the display device 30, the first flat face 251 of the other of the above-mentioned two second projecting portions 25 (the lower second projecting portion 25) faces toward the front of the display device 30. Then, the container 20 moves frontward. On this occasion, the first flat face 251 engages against the first pin 521A on the left-hand side of the movement route. As a result, the container 20 rotates clockwise. After that, the second flat face 252 engages against the second pin 522A on the same left-hand side, and thus, the container 20 further rotates. Also, the third flat face 253 engages against the third pin 523A on the same left-hand side, and thus, the container 20 further rotates. Thereby, the identification mark 23 comes to face frontward.

Here, the first to third pins 521A to 523A located on the left-hand side of the movement route are positioned below the first to third pins 521A to 523A located on the right-hand side of the movement route (on a side closer to the placement unit 31) for correspondence with the above-mentioned other second projecting portion 25 (the lower second projecting portion 25).

In the case of the container 20 provided with one identification mark 23 shown in FIGS. 69 and 70, the configuration shown in FIGS. 34A to 40B may be adopted to make the identification mark 23 face toward the front; however, this configuration requires six pins, namely, the first to sixth pins 521A to 526A, as described above. As mentioned in addition, rotation of close to 360 degrees of the container 20 is required, and therefore, the pins are arranged up to the vicinity of the taken-out portion for the containers 20, as shown also in FIGS. 34A and 34B. This situation might render it difficult to take out the containers 20.

In the case of the container 20 shown in FIGS. 69 and 70, the number of pins may be reduced as compared to the configuration shown in FIGS. 34A and 34B, and the pins may be provided for example on an upper side of the display device 30. This makes it easier to take out the containers 20. Also, when six pins, namely, the first to sixth pins 521A to 526A, are required (when rotation of close to 360 degrees of the container 20 is required), the length of the display device 30 becomes longer in the front-back direction thereof. In the case of the configuration shown in FIGS. 69 to 71B, the container 20 has to be rotated only by 180 degrees at the maximum, and thus, the display device 30 may have a short length in the front-back direction.

### Eighth Exemplary Embodiment

Description has been given above with regard to an example in which the second projecting portion 25 is used to make the identification mark 23 of the container 20 face frontward. Incidentally, the container 20 may be configured in the following manner.

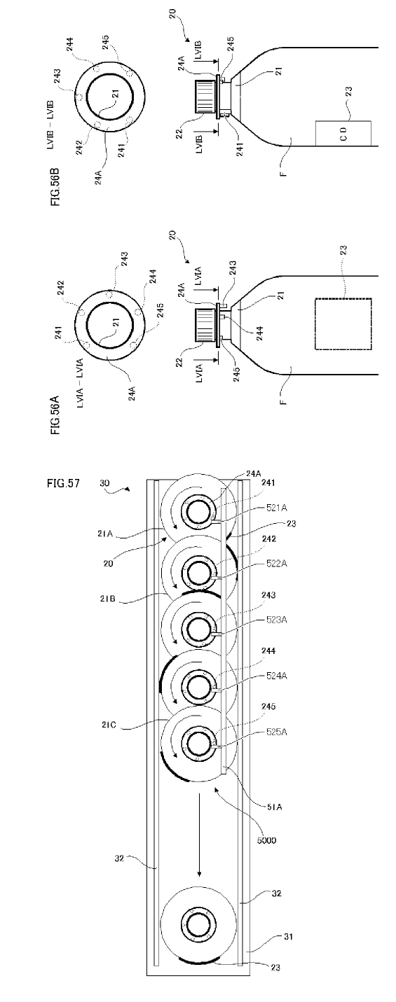

FIG. 55 (FIGS. 55A and 55B) and FIG. 56 (FIGS. 56A and 56B) are views showing the container 20 according to the eighth exemplary embodiment. FIG. 55A shows a front elevational view of the container 20, and FIG. 55B shows a left side view of the container 20. Also, FIG. 56A shows a rear elevational view of the container 20, and FIG. 56B shows a right side view of the container 20. Also, views shown in upper parts of FIGS. 55A and 55B and FIGS. 56A and 56B show cross-sectional views taken along the line LVA-LVA, the line LVB-LVB, the line LVIA-LVIA, and the line LVIB-LVIB, respectively.

The container 20 according to this exemplary embodiment includes first to fifth protrusions 241 to 245 each in the form of a rod, provided under the first projecting portion 24A and projecting downward from the first projecting portion 24A. Here, the first to fifth protrusions 241 to 245 are provided in the circumferential direction of the container 20. Also, the first to fifth protrusions 241 to 245 are provided so that the first protrusion 241, the second protrusion 242, the third protrusion 243, the fourth protrusion 244 and the fifth protrusion 245 are arranged in this order in the circumferential direction of the container 20 (in the clockwise direction). Further, the first to fifth protrusions 241 to 245 are arranged at substantially equal intervals.

Also, the first protrusion 241 is provided on a side closer to the side on which the identification mark 23 is provided and which is closer to the right side face of the container 20 (see FIG. 55A). Also, the fifth protrusion 245 is provided on a side which is opposite to the side on which the identification mark 23 is provided and which is closer to the right side face of the container 20 (see the cross-sectional view of FIG. 55A). Also, the second to fourth protrusions 242 to 244 are arranged between the first protrusion 241 and the fifth protrusion 245.

Further, the first protrusion 241 is largest in the amount of projection from the first projecting portion 24A, which is followed by the second protrusion 242. Also, the amount of projection of the third protrusion 243 is smaller than that of the second protrusion 242, and the amount of projection of the fourth protrusion 244 is smaller than that of the third protrusion 243. The amount of projection of the fifth protrusion 245 is smallest. The container 20 according to this exemplary embodiment is not provided with any protrusions at a position rightward of the tangent line to the container body 21 (see also FIG. 39A).

Description will now be given with regard to behavior of the container 20 according to this exemplary embodiment.

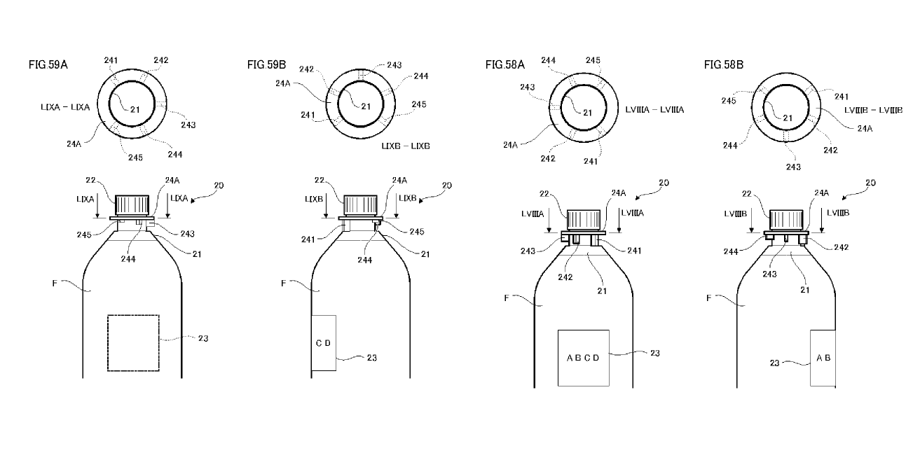

FIG. 57 is a view showing the behavior of the container 20 in the display device 30. As indicated for example by the reference numeral 21A in FIG. 57, when the container 20 is supplied to the display device 30 with the identification mark 23 facing diagonally forward right, the first protrusion 241 engages against the first pin 521A. Thereby, rotational force is applied to the container 20, so that the container 20 makes counterclockwise rotation. Then, as the container 20 moves frontward, the second protrusion 242 engages against the second pin 522A (see the reference numeral 21B), and thus, the container 20 likewise makes counterclockwise rotation.

After that, the container 20 makes circumferential rotation in sequence by the third protrusion 243 engaging against the third pin 523A, and then the fourth protrusion 244 engaging against the fourth pin 524A. Finally, the fifth protrusion 245 engages against the fifth pin 525A (see the reference numeral 21C), so that the identification mark 23 comes to face frontward. After that, the container 20 slides on the placement unit 31 and reaches the front of the display device 30. Here, the display device 30 shown in FIGS. 34A and 34B is used as the display device 30 shown in FIG. 57. In the display device 30, the number of pins is five corresponding to the number of protrusions (the first to fifth protrusions 241 to 245). In this exemplary embodiment, description has been given by taking a case where five protrusions, namely, the first to fifth protrusions 241 to 245, and five pins, namely, the first to fifth pins 521A to 525A, are provided, as an example; however, the numbers of protrusions and pins may be appropriately increased. The numbers of protrusions and pins are increased thereby to achieve smoother rotation of the container 20.

The container 20 may be configured in the following manner.

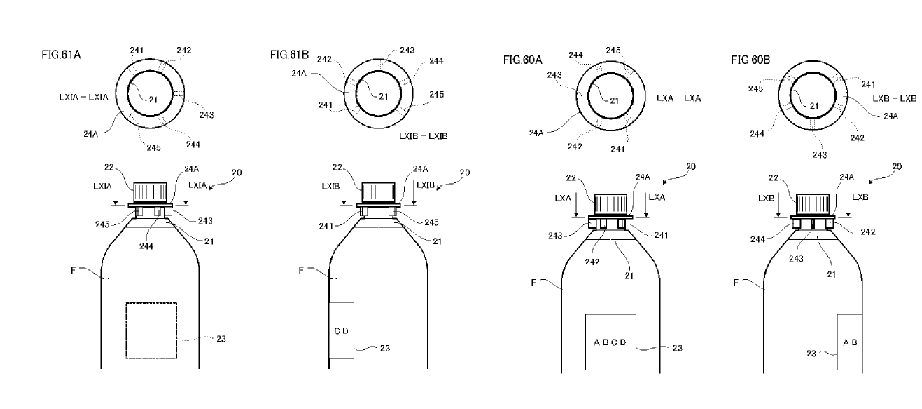

FIG. 58 (FIGS. 58A and 58B) and FIG. 59 (FIGS. 59A and 59B) are views showing a modified example of the container 20. FIG. 58A shows a front elevational view of the container 20, and FIG. 58B shows a left side view of the container 20. Also, FIG. 59A shows a rear elevational view of the container 20, and FIG. 59B shows a right side view of the container 20. Also, views shown in upper parts of FIGS. 58A and 58B and FIGS. 59A and 59B show cross-sectional views taken along the line LVIIIA-LVIIIA, the line LVIIIB-LVIIIB, the line LIXA-LIXA, and the line LIXB-LIXB, respectively.

In the container 20 shown in these figures, the first to fifth protrusions 241 to 245 are each given the form of a plate (or a rib), rather than the form of a rod. Also, the first to fifth protrusions 241 to 245 are radially arranged. Also, the first to fifth protrusions 241 to 245 are supported not only by the first projecting portion 24A but also by the container body 21. Thus, in the container 20 according to this modified example, strength of the first to fifth protrusions 241 to 245 may be increased, as compared to an aspect shown in FIGS. 55A to 56B.

Further, the container 20 may have the following configuration.

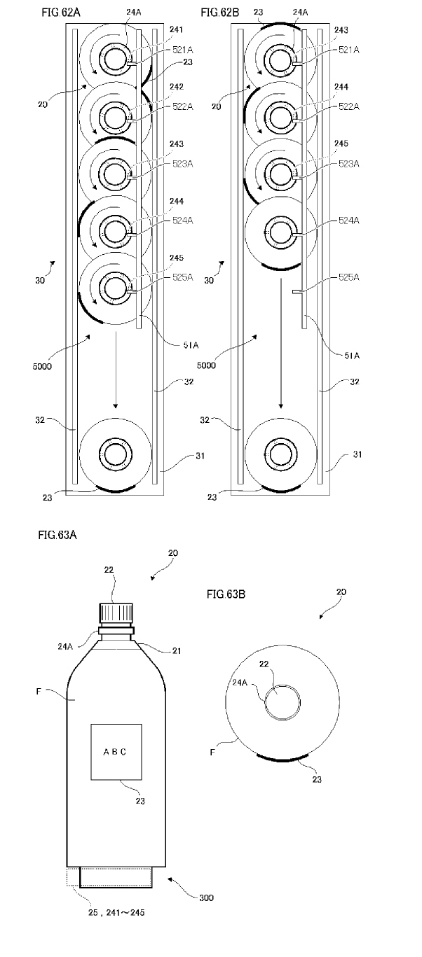

FIG. 60 (FIGS. 60A and 60B) and FIG. 61 (FIGS. 61A and 61B) are views of another modified example of the container 20. FIG. 60A shows a front elevational view of the container 20, and FIG. 60B shows a left side view of the container 20. Also, FIG. 61A shows a rear elevational view of the container 20, and FIG. 61B shows a right side view of the container 20. Also, views shown in upper parts of FIGS. 60A and 60B and FIGS. 61A and 61B are cross-sectional views taken along the line LXA-LXA, the line LXB-LXB, the line LXIA-LXIA, and the line LXIB-LXIB, respectively.

In the above FIGS. 55A to 59B, the first to fifth protrusions 241 to 245 are made different from one another in height, and the first to fifth pins 521A to 525A of the display device 30 are made different from one another in height. Meanwhile, the first to fifth protrusions 241 to 245 may have the same dimension in the height direction, as shown in FIGS. 60A to 61B. In other words, a configuration may be such that there is no difference in the dimension in the height direction among the first to fifth protrusions 241 to 245. Also, the heights of the first to fifth pins 521A to 525A of the display device 30 (the heights of the first to fifth pins 521A to 525A from the placement unit 31) may be the same.

Here, FIG. 62 (FIGS. 62A and 62B) is a view showing behavior of the container 20 in the display device 30. In the display device 30 in FIGS. 62A and 62B, the heights of the first to fifth pins 521A to 525A are not made different from one another, and thus, the first to fifth pins 521A to 525A are arranged at substantially the same height from the placement unit 31.

Here, as shown for example in FIG. 62A, when the container 20 is supplied with the identification mark 23 facing diagonally forward right, the first protrusion 241 first engages against the first pin 521A. Thereby, the container 20 makes counterclockwise rotation. After that, the container 20 makes rotation in sequence by the second protrusion 242 engaging against the second pin 522A, the third protrusion 243 engaging against the third pin 523A, and the fourth protrusion 244 engaging against the fourth pin 524A. Then, the container 20 further rotates by the fifth protrusion 245 engaging against the fifth pin 525A. As a result, the identification mark 23 comes to face frontward.

Also, as shown for example in FIG. 62B, when the container 20 is supplied with the identification mark 23 facing backward, the third protrusion 243 first engages against the first pin 521A. Thereby, the container 20 makes counterclockwise rotation. After that, the container 20 makes rotation in sequence by the fourth protrusion 244 engaging against the second pin 522A, and the fifth protrusion 245 engaging against the third pin 523A. Thereby, the identification mark 23 comes to face frontward. Then, in this case, a portion where the first to fifth protrusions 241 to 245 are not provided is in such a position to face the side on which the first to fifth pins 521A to 525A are arranged. As a result, the container 20 moves frontward without engaging against the remaining fourth and fifth pins 524A and 525A.

In the seventh exemplary embodiment and the eighth exemplary embodiment mentioned above, description has been given with regard to an example in which the second projecting portion 25 or the first to fifth protrusions 241 to 245 are provided under the first projecting portion 24A. Incidentally, the container 20 may have the following configuration.

FIG. 63 (FIGS. 63A and 63B) is a view showing another example of the modified examples of the container 20. FIG. 63A shows a front elevational view, and FIG. 63B shows a top view.

The second projecting portion 25 or the first to fifth protrusions 241 to 245 may be provided not only under the first projecting portion 24A, but also in the bottom portion side of the container 20 as shown in FIGS. 63A and 63B. For example, a concave portion 300 may be formed by reducing the diameter of the bottom portion of the container 20 as shown in FIGS. 63A and 63B, whereby the second projecting portion 25 or the first to fifth protrusions 241 to 245 may be provided in the concave portion 300.

Here, FIG. 64 (FIGS. 64A and 64B) is a view showing another example of the modified examples of the container 20. FIG. 64A shows a front elevational view, and FIG. 64B shows a top view.

The container 20 shown in FIGS. 64A and 64B is illustrated as what is called a two-piece can. The container 20 includes an annular projecting portion 402 that is provided in a bottom portion 401 and that annularly projects in a direction away from the bottom portion 401.

Although the resin-made container 20 has been described above by way of example, a container 20 such as a steel can or an aluminum can may be provided with the second projecting portion 25 or the first to fifth protrusions 241 to 245. Here, the second projecting portion 25 or the first to fifth protrusions 241 to 245 may be provided for example around the above-mentioned annular projecting portion 402, as shown in FIGS. 64A and 64B. Here, the second projecting portion 25 or the first to fifth protrusions 241 to 245 may be formed at the time of formation of the container 20, as in the case of the above. Also, for example, attachment or the like of other members such as resin pieces or metal pieces may be separately performed to form the second projecting portion 25 or the first to fifth protrusions 241 to 245.

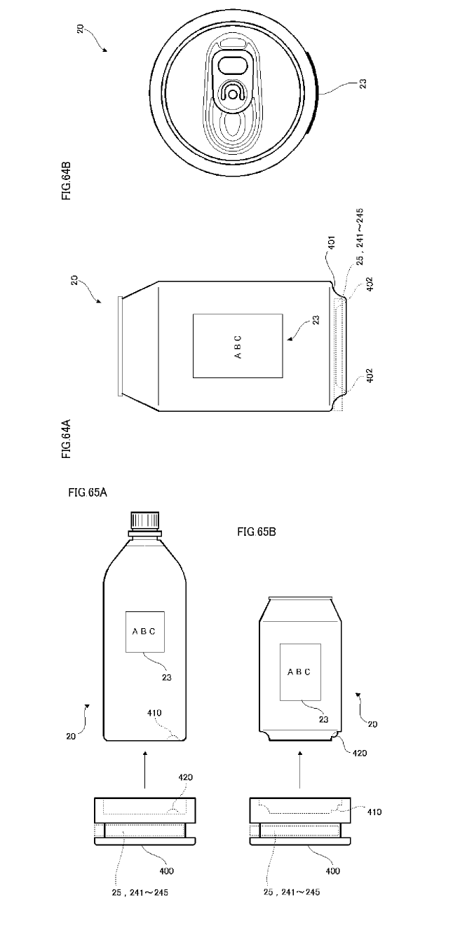

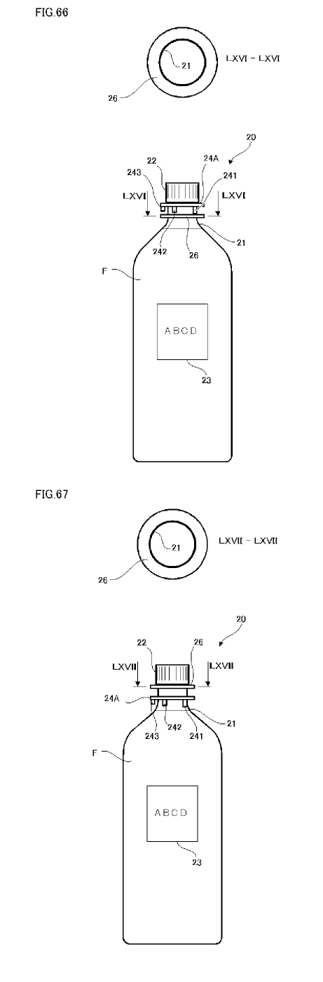

FIG. 65 (FIGS. 65A and 65B) is a view showing another example of the modified examples of the container 20 and so on.

Description has been given above with regard to an example in which the second projecting portion 25 or the first to fifth protrusions 241 to 245 are provided directly on the container 20; however, the second projecting portion 25 or the first to fifth protrusions 241 to 245 may be provided to the container 20 by forming the second projecting portion 25 or the first to fifth protrusions 241 to 245 on a different member from the container 20, and then by mounting the different member on the container 20.

FIGS. 65A and 65B show an example where the second projecting portion 25 or the first to fifth protrusions 241 to 245 are formed on a mounting member (a mounting member body) 400 to be mounted on the bottom portion of the container 20, and the mounting member 400 having the second projecting portion 25 or the first to fifth protrusions 241 to 245 formed thereon is mounted on the container 20. It is preferable that, as shown in FIG. 65A, a concave portion 410, for example, be formed in the container 20, and a convex portion 420 fitting in the concave portion 410 be formed on the mounting member 400. In this case, alignment between the identification mark 23 and the second projecting portion 25 or the like is simplified. Note that as shown in FIG. 65B, the concave portion 410 may be provided in the mounting member 400, and the convex portion 420 may be provided on the container 20.

FIG. 66 is a view showing another example of the modified examples of the container 20. A view shown in an upper part of FIG. 66 is a cross-sectional view taken along the line LXVI-LXVI.

The container 20 shown in FIG. 66 is configured so that a third projecting portion 26 having the same shape as the first projecting portion 24A is provided under the first to fifth protrusions 241 to 245. As mentioned in addition, a configuration is such that the third projecting portion 26 in the form of a disc (a brim) is provided under a region where the second projecting portion 25 or the first to fifth protrusions 241 to 245 are provided.

Here, a portion projecting annularly from the container body 21, as is the case with the first projecting portion 24A, may be supported from below by two rails or the like, thereby to allow smooth transport of the container 20 in some cases. Also, when the cap 22 is mounted after drink filling, it may be desired to support the first projecting portion 24A from below in some cases.

In such a case, the provision of the first to fifth protrusions 241 to 245 or the like might render it difficult to transport the container 20, or render it difficult to mount the cap 22. The provision of the third projecting portion 26 under the first to fifth protrusions 241 to 245, as is the case with this exemplary embodiment, may prevent the above-mentioned problems from arising.

The container 20 may have a shape as given below.

FIG. 67 is a view showing another example of the modified examples of the container 20. A view shown in an upper part of FIG. 67 is a cross-sectional view taken along the line LXVII-LXVII.

In the container 20 shown in FIG. 67, the first projecting portion 24A is positioned below its position shown in FIG. 66, and the first to fifth protrusions 241 to 245 are provided under the first projecting portion 24A. Also, in the container 20, the third projecting portion 26 is provided above the first projecting portion 24A. Here, the third projecting portion 26 is arranged with a gap between the third projecting portion 26 and the first projecting portion 24A, and the gap is configured to admit the above-mentioned rails The container 20 shown in FIG. 67 also may prevent the above-mentioned problems from arising.

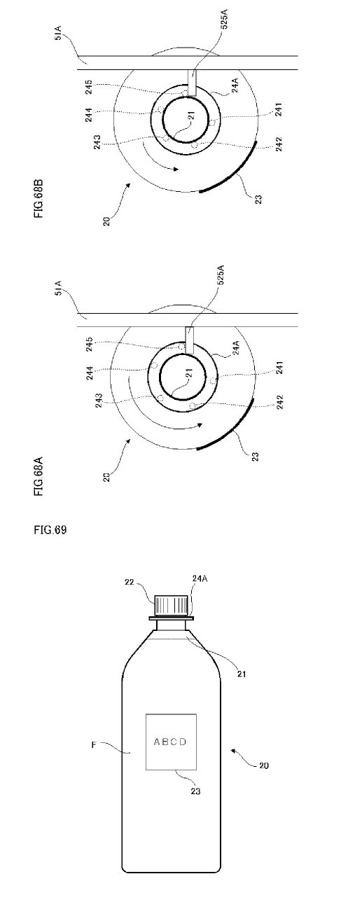

It is preferable that the above-described first to fifth protrusions 241 to 245 each in the form of a rod (see FIGS. 55A to 56B) be arranged on an outer periphery side of the first projecting portion 24A. For example, if the first to fifth protrusions 241 to 245 are arranged near the container body 21 as shown in FIG. 68B (FIG. 68 (FIGS. 68A and 68B) is a view for explaining an aspect of the arrangement of the first to fifth protrusions 241 to 245.), the amount of rotation of the container 20 per one rotation becomes small.

On the other hand, when the first to fifth protrusions 241 to 245 are arranged on the outer periphery side of the first projecting portion 24A, the amount of rotation of the container 20 per one rotation may become larger as shown in FIG. 68A. As a result, an increase in the number of protrusions (the first to fifth protrusions 241 to 245) and an increase in the number of pins (the first to sixth pins 521A to 526A) may be suppressed. For the same reason as described above, it is preferable that the first to fifth protrusions 241 to 245 each in the form of a rib (see FIGS. 58A to 59B) be provided extending as far as the outer periphery of the first projecting portion 24A.

In the above-described configurations, the container 20 filled with drink has been described by way of example; however, the container 20 is not limited to that filled with drink. For example, a container 20 filled with cosmetics, a container 20 filled with liquid soap, or the like may be given by way of example. Also, the present invention is not limited to the container 20 filled with a filling therein. As long as it is a product (an article) provided with an identification mark 23, the above-mentioned configurations may be utilized to make the identification mark 23 face frontward (a specific direction).

### REFERENCE SIGNS LIST

20 Container
21 Container body
22 Cap
23 Identification mark
23a First identification mark
23b Second identification mark
24 Projecting portion
25 Second projecting portion
30 Display device
31 Placement unit
32 Guide
33 Resistance application portion
35 Upper guide
35b Concave and convex portion
50 Container body
210 Bottom portion
213 Projecting portion
251 First flat face
252 Second flat face
253 Third flat face
254 Fourth flat face
255 Fifth flat face
256 Sixth flat face
314 Roll-shaped member
350 Second guide
351 Left-hand-side upper guide
352 Right-hand-side upper guide
400 Mounting member
521A First pin
522A Second pin
523A Third pin
524A Fourth pin
525A Fifth pin
526A Sixth pin
600 Mounting member
R1 First region
R2 Second region

1. A display system comprising:
a container that has a mark attached on an outer circumferential face thereof; and
a display device that displays the container, wherein
the display device includes:
a movement unit that moves the container; and
a rotation unit that rotates, in a circumferential direction, the container moved by the movement unit to make the mark of the container face a specific direction, when the mark does not face the specific direction.

2. The display system according to claim 1, wherein
the rotation unit supports the container from below by using a supporting portion and applies resistance force to the moving container by using the supporting portion so as to rotate the container in the circumferential direction, when the container is supplied to the display device in a state where the mark does not face the specific direction, and
the rotation unit drops the container downward to stop the rotation of the container, when the mark comes to face the specific direction.

3. The display system according to claim 1, wherein
the container has a first region and a second region on the outer circumferential face and in different positions in the circumferential direction, and has the mark in a position having a predetermined positional relationship with the second region, the second region having a friction coefficient lower than the first region, and
the rotation unit rotates the container in the circumferential direction by applying resistance force to the first region of the container moved by the movement unit, and makes the mark of the container face the specific direction by sliding on the second region, when the mark does not face the specific direction.

4. The display system according to claim 1, wherein
the container includes, in different positions in the circumferential direction, a plurality of faces arranged in an intersecting relationship with the outer circumferential face on which the mark is attached, and
the rotation unit has a contact portion that sequentially comes into contact with the plurality of faces, of the container, arranged in the intersecting relationship, the container being moved by the movement unit, and rotates the container in the circumferential direction by using the contact portion to make the mark face the specific direction.

5. A display device comprising:
a movement unit that moves a container with a mark attached on an outer circumferential face thereof; and
a rotation unit that rotates, in a circumferential direction, the container moved by the movement unit to make the mark of the container face a specific direction, when the mark does not face the specific direction.

6. A container display system comprising:
a container that has a mark attached on an outer circumferential face thereof;
a movement path on which the container moves while rotating; and
a movement unit that is arranged below the movement path, and that moves the container without rotation, wherein
the container is allowed to drop from the movement path to the movement unit, when the mark faces a specific direction set in advance while the container is moving and rotating on the movement path.

7. The container display system according to claim 6, further comprising a taken-out portion from which the container moved by the movement unit is taken out, wherein
the container drops from the movement path to the movement unit when the mark comes to face the taken-out portion side, and
the movement unit moves the container with the mark facing the taken-out portion side as far as the taken-out portion, the container having dropped from the movement path.

8. The container display system according to claim 6, wherein
the container has a portion whose width in a direction of the mark is formed as a first width, and whose width in a direction orthogonal to the direction of the mark is formed as a second width smaller than the first width,
the movement path is provided with a pair of guides that are arranged side by side at an interval smaller than the first width and larger than the second width, and
the container receives support for the portion from the pair of guides when the mark faces a direction other than the specific direction, and is made the support released to drop to the movement unit when the mark comes to face the specific direction.

9. The container display system according to claim 6, wherein rotation of the container on the movement path is conducted by applying resistance force to a part of the container that is going to slide and move on the movement path.

10. A container display system comprising:
a container that has a mark attached on an outer circumferential face thereof;
a first movement unit that moves the container while rotating the container;
a second movement unit that moves the container to a taken-out portion for the container without rotating the container; and
a delivery unit that delivers, from the first movement unit to the second movement unit, the container moved and rotated by the first movement unit, when the mark of the container faces a specific direction set in advance.

11. The container display system according to claim 10, wherein
the first movement unit is arranged above the second movement unit, and
the delivery unit delivers the container from the first movement unit to the second movement unit by dropping the container.

12. The container display system according to claim 11, wherein
the first movement unit and the second movement unit are arranged from a supplying portion of the container toward the taken-out portion, and
the first movement unit is arranged from the supplying portion to a predetermined position, and is not arranged above the taken-out portion.

13. The container display system according to claim 10, wherein
the container has a portion whose width in a direction of the mark is formed as a first width, and whose width in a direction orthogonal to the direction of the mark is formed as a second width smaller than the first width,
the first movement unit includes a pair of guides that are arranged side by side at an interval smaller than the first width and larger than the second width, and that moves the container while rotating the container, and
the delivery unit delivers the container from the first movement unit to the second movement unit by using the portion of the container and the pair of guides.

14. The container display system according to claim 10, wherein the first movement unit supports the container above a position of the center of gravity of the container, and moves the container while rotating the container.

15. A container comprising:
a container body that has a lower portion and that is capable of being filled with a content; and
a mark that is attached on an outer circumferential face of the container body, wherein
the container body has:
a wide-width portion whose width in a direction of the mark is a first width, and that is capable of supporting the container body with the first width; and
a narrow-width portion whose width in a direction orthogonal to the direction of the mark is a second width smaller than the first width, and that is formed continuously with the wide-width portion.

16. The container according to claim 15, further comprising a projecting portion that projects into a radial direction of the container body from the outer circumferential face of the container body, wherein
the wide-width portion is formed of the projecting portion.

17. The container according to claim 15, wherein the wide-width portion is formed at an upper part of the container body.

18. A display system comprising:
a container that has a mark attached thereon; and
a display device that displays the container, wherein
the display device includes:
a movement unit that moves the container; and
a guide portion that guides movement of the container by coming into contact with the container moved by the movement unit, and
the container includes:
a container body that has the mark attached thereon;
a first contact portion that comes into contact with the guide portion when the mark faces a direction other than a specific direction, and that rotates the container body by using resistance force from the guide portion to make the mark face the specific direction; and
a second contact portion that comes into contact with the guide portion when the mark faces the specific direction, and that slides the container body with respect to the guide portion.

19. The display system according to claim 18, wherein the first contact portion and the second contact portion are formed of any one of an application material applied to the container body and an application material applied to a mounting member mounted on the container body.

20. The display system according to claim 18, wherein
the guide portion is disposed from a supplying portion side, to which the container is supplied, toward a taken-out portion side, from which the container is taken out,
the guide portion has a resistance force increasing member attached along a direction in which the guide portion is disposed, the resistance force increasing member increasing a resistance force applied to the container coming into contact with the guide portion, and
the resistance force increasing member is attached not to the whole region but to a part of the region of the guide portion.

21. The display system according to claim 18, wherein
the guide portion forms a movement route of the container, is arranged at a lateral side of the movement route, and performs guidance by coming into contact with one side of the container that is moving, and
the display system further includes a rotation restricting portion that restricts rotation of the container by coming into contact with the other side of the container moving on the movement route.

22. The display system according to claim 18, wherein the first contact portion has a plurality of projecting portions projecting from an outer face of the container body, and rotates the container body by causing the plurality of projecting portions to be opposed to a plurality of protruding portions provided for the guide portion, so as to make the mark face the specific direction.

23. A container that is displayable in a display system including a guide portion guiding movement of a displayed object by coming into contact with the displayed object, the container comprising:
a container body that has a mark attached thereon;
a first contact portion that comes into contact with the guide portion when the mark faces a direction other than a specific direction, and that rotates the container body by using resistance force from the guide portion to make the mark face the specific direction; and
a second contact portion that comes into contact with the guide portion when the mark faces the specific direction, and that slides the container body with respect to the guide portion.

24. The container according to claim 23, wherein
the second contact portion has concavities and convexities in and on a surface thereof, and
the first contact portion is formed more smoothly than the second contact portion.

25. The container according to claim 24, wherein the concavities and convexities of the second contact portion are formed of an application material applied to the second contact portion.

26. The container according to claim 23, wherein the first contact portion and the second contact portion are formed by attaching any one of a sticker and tape to at least any one of the first contact portion and the second contact portion.

27. A container comprising:
a container body that is capable of being filled with a content;
a mark that is attached on an outer circumferential face of the container body;
a first region that has a first friction coefficient, and that is formed on the outer circumferential face of the container body; and
a second region that has a second friction coefficient lower than the first friction coefficient, and that is formed on the outer circumferential face and in a different position, in a circumferential direction of the container body, from a position in which the first region is formed, wherein
the mark is arranged in a predetermined positional relationship with the second region, and is attached on the outer circumferential face so as to face a direction intersecting with one direction when the second region faces the one direction.

28. The container according to claim 27, wherein the mark is attached on the outer circumferential face so as to face a direction substantially orthogonal to the one direction when the second region faces the one direction.

29. A container comprising:
a container body that is capable of being filled with a content;
a mark that is attached on an outer circumferential face of the container body;
a first region that is formed on an outer face of the container body, and that has a plurality of projecting portions; and
a second region that is formed more smoothly than the first region, and that is formed on the outer face and in a different position, in a circumferential direction of the container body, from a position in which the first region is formed, wherein
the mark is arranged in a predetermined positional relationship with the second region, and is attached on the outer circumferential face so as to face a direction intersecting with one direction when the second region faces the one direction.

30. The container according to claim 29, wherein the mark is attached on the outer circumferential face so as to face a direction substantially orthogonal to the one direction when the second region faces the one direction.

31. The container according to claim 29, wherein
the container body that is formed into a tubular shape has a lower portion side closed, and
the first region is formed on the lower portion of the container body.

32. The container according to claim 29, wherein the plurality of projecting portions in the first region are integrally formed with the container body.

33. The display system according to claim 18, wherein the first contact portion and the second contact portion are any one of being formed on a mounting member mounted on the container body, and being formed on the container body and the mounting member.

34. A film that is to be mounted on an outer circumferential face of a container which is displayable in a display system including: a movement unit moving a displayed object; and a guide portion guiding movement of the displayed object by coming into contact with an outer circumferential face of the displayed object moved by the movement unit, the film comprising:
a first region that has a first friction coefficient;
a second region that has a second friction coefficient lower than the first friction coefficient, and that is placed in a different position, in a circumferential direction of the container, from a position in which the first region is placed, when the film is mounted on the outer circumferential face of the container; and
a mark that is formed in a position having a predetermined positional relationship with the second region.

35. The film according to claim 34, wherein at least any one of the first region and the second region is formed by applying an application material.

36. The film according to claim 34, wherein the film is heat-shrinkable.

37. A display system comprising:
an article that has a mark attached on an outer circumferential face thereof; and
a display device that displays the article, wherein
the display device includes:
a movement path on which the article moves; and
protruding portions that are arranged in a plurality of positions in a movement direction of the article, and that protrude into the movement path,
the article includes:
an article body portion that has the outer circumferential face;
a plurality of contact portions that are arranged in a circumferential direction of the article body portion and within a predetermined range in the circumferential direction, and that are capable of coming into contact with the protruding portions provided in the display device; and
a region that is adjacent to the predetermined range in the circumferential direction, and in which the plurality of contact portions are not provided,
the plurality of contact portions sequentially come into contact with the protruding portions to rotate, in the circumferential direction, the article moving on the movement path, when the mark of the article does not face a specific direction, and
the region is opposed to a side on which the protruding portions are provided, to move the article without rotation, when the mark faces the specific direction.

38. The display system according to claim 37, wherein the plurality of contact portions are arranged in positions different from each other in a height direction of the article.

39. The display system according to claim 38, wherein the protruding portions are provided in positions different from each other in a height direction so that each of the protruding portions comes into contact with one contact portion among the plurality of contact portions and does not come into contact with the other contact portions.

40. The display system according to claim 37, wherein the plurality of contact portions are formed of projecting portions that project into a radial direction of the article body portion from the outer circumferential face.

41. The display system according to claim 37, wherein
the article further includes a mounting member mounted on the article body portion, and
the plurality of contact portions and the region are formed on the mounting member, and are provided for the article by mounting the mounting member on the article body portion.

42. A display device that is capable of displaying an article which includes: an outer circumferential face with a mark attached thereon; and a plurality of faces having an intersecting relationship with the outer circumferential face, in different positions in a circumferential direction and within a predetermined range in the circumferential direction, the display device comprising:
a movement path on which the article moves; and
a rotation unit that sequentially comes into contact with the plurality of faces having the intersecting relationship to rotate the article moving on the movement path, when the mark of the article faces a direction other than a specific direction, and that is opposed to a face which is the outer circumferential face of the article moving on the movement path and on which the plurality of faces having the intersecting relationship are not provided, when the mark of the article faces the specific direction.

43. The display device according to claim 42, wherein the rotation unit is provided so that a position thereof in a height direction is adjustable.

44. The display device according to claim 42, wherein the rotation unit includes protruding portions protruding into the movement path, in a plurality of positions in a movement direction of the article, and causes the protruding portions to sequentially come into contact with the plurality of faces having the intersecting relationship so as to perform rotation of the article.

45. An article comprising:
an article body portion that has an outer circumferential face with a mark attached thereon; and
a face forming portion that is arranged in a predetermined positional relationship with the mark, and that is provided, in a circumferential direction of the article body portion, with a plurality of faces arranged in an intersecting relationship with the outer circumferential face.

46. The article according to claim 45, further comprising a portion that is arranged in a predetermined positional relationship with the mark, that is provided, in the circumferential direction, so as to be adjacent to the face forming portion, and on which the plurality of faces arranged in the intersecting relationship are not provided.

47. The article according to claim 46, wherein the portion on which the plurality of faces arranged in the intersecting relationship are not provided is arranged so as to face a direction substantially orthogonal to one direction when the mark faces the one direction.

48. The article according to claim 45, further comprising another face forming portion in a position different from a position of the face forming portion in a height direction.

49. The article according to claim 45, wherein
a plurality of the marks are provided in different positions in the circumferential direction,
the face forming portion is arranged in the predetermined positional relationship with one mark among the plurality of marks, and
the article further includes another face forming portion arranged in a predetermined positional relationship with the another mark among the plurality of marks.

50. The article according to claim 49, wherein the face forming portion arranged in the predetermined positional relationship with the other mark is arranged in a different position, in a height direction, from a position of the face forming portion arranged in the predetermined positional relationship with the one mark.

51. The article according to claim 45, wherein the plurality of faces arranged in the intersecting relationship are arranged in positions different from each other in a height direction of the article body portion.

52. A mounting member that is to be mounted on an article with a mark attached thereon, the mounting member comprising:
a body portion that has an outer circumferential face, and that is mounted on the article; and
a face forming portion that is provided, in a circumferential direction of the body portion, with a plurality of faces arranged in an intersecting relationship with the outer circumferential face, and that is placed in a position having a predetermined positional relationship with the mark, when the body portion is mounted on the article in a state where the article and the body portion have a predetermined positional relationship.
